(19) United States
(12) Patent Application Publication
(10) Pub. No.: US 2015/0211479 A1
(43) Pub. Date: Jul. 30, 2015

(54) Buoyancy-driven Kinetic Energy Generating Apparatus and Method for Generating Kinetic Energy by Using the Same

(71) Applicant: Chun-I Tai, Kaohsiung City (TW)

(72) Inventors: Chun-I Tai, Kaohsiung City (TW); Wen-Ching Huang, Kaohsiung City (TW); Wen-Kuan Chen, Kaohsiung City (TW)

(73) Assignee: Chun-I Tai, Kaohsiung City (TW)

(21) Appl. No.: 14/228,529

(22) Filed: Mar. 28, 2014

(30) Foreign Application Priority Data
Jan. 29, 2014 (TW) 103103352
Feb. 27, 2014 (TW) 103106776

(51) Int. Cl. F03B 17/02; F03B 15/00

(52) U.S. Cl. CPC F03B 17/02; F03B 15/00

(57) ABSTRACT

A buoyancy-driven kinetic energy generating apparatus includes a base having a tank. A rotor includes a rotor body rotatably received in the tank. At least one float telescopes relative to the rotor body to a rotating axis of the rotor body while the rotor body rotates. A telescopic movement control module is mounted in the tank and controls the telescopic movement of the at least one float. A method generates kinetic energy by using the buoyancy-driven kinetic energy generating apparatus. The method includes filling a liquid into the tank to provide the rotor body with a pre-buoyancy and controlling the at least one float to telescope relative to the rotor body, causing a change in local buoyancy of the rotor body to imbalance the rotor body and to cause rotation of the rotor body about the rotating axis.

### BACKGROUND OF THE INVENTION

1. Field of the Invention

The present invention relates to an apparatus for generating kinetic energy and, more particularly, to a buoyancy-driven kinetic energy generating apparatus and method for generating kinetic energy by using the buoyancy-driven kinetic energy generating apparatus.

2. Description of the Related Art

In the developing history of human civilization, many kinetic energy generating apparatuses capable of generating kinetic energy have been proposed to drive a device or to covert the kinetic energy into electric energy for wider applications, improving the life quality of human. These kinetic energy generating apparatuses are generally of two types: one of them uses natural energy as the power for generating kinetic energy, such as wind power generation, solar power generation, hydro-power generation, etc., and the other consumes natural resources to generate the power for generating kinetic energy, such as nuclear power generation, coal-fired power generation, etc. However, these kinetic energy generating apparatuses still have disadvantages.

Firstly, although the kinetic energy generating apparatuses using natural energy is cheap, abundant, and pollutionless, the occurrences of the natural energy and its intensity can not be controlled such that maintaining a stable energy generating efficiency of the kinetic energy generating apparatuses using natural energy is difficult.

Secondly, although the kinetic energy generating apparatuses consuming natural resources can easily be controlled, the natural resources are not exhaustless. The natural resources will exhaust someday under large-scale mining by the human. Furthermore, operation of the kinetic energy generating apparatuses consuming natural resources not only have safety risks but generates waste (such as nuclear waste) causing severe environmental pollution. Treatment of the waste further incurs tricky and costly problems.

To solve the above problems, a buoyancy-driven kinetic energy generating device utilizing buoyancy has been developed. With reference to FIG. 1, a conventional buoyancy-driven kinetic energy generating device 9 includes a tower 91 receiving a conveyor 92. The conveyor 92 is connected to and drives a rotary shaft 93 to rotate. The rotary shaft 93 is connected to a generator 94 outside of the tower 91. A plurality of buckets 921 is mounted to the conveyor 92. An opening of each bucket 921 faces downward when it is adjacent to a bottom of the tower 91. A bubble supply means 95 fills gas bubbles into the bucket 921 reaching a lower portion of a side of the conveyor 92 to generate buoyancy. When the bucket 921 with bubbles moves upward to a position above the water surface, the gas in the bucket 921 is discharged, and the bucket 921 sinks into the water with the opening of the bucket 921 facing upward to receive water for smooth sinking. An example of such a buoyancy-driven kinetic energy generating device is disclosed in U.S. Pat. No. 7,216,483 entitled “POWER GENERATING SYSTEM UTILIZING BUOYANCY”.

However, operation of the buoyancy-driven kinetic energy generating device 9 requires additional power to actuate the bubble supply means 95 for generating bubbles and filling the bubbles into the buckets 921 so as to continuously drive the conveyor 92 by buoyancy to thereby drive the generator 94 to generate electric energy. Furthermore, since the buoyancy-driven kinetic energy generating device can only use the buoyancy of less than half of the buckets 921 to drive the conveyor 92 while each bucket 921 has a limited capacity, it is difficult to increase the total buoyancy, resulting in inefficient operation of the conveyor 92.

Furthermore, the buoyancy-driven kinetic energy generating device 9 has many components leading to high costs in manufacture, assembly, and maintenance. During operation, the conveyor 92 and the rotary shaft 93 are connected by a chain and gears moving in the water. These mechanical components have high friction therebetween and, thus, can not move smoothly without sufficient lubrication. Operation in the water causes difficult lubrication and increases the resistance to meshing. All of these increase the resistance during operation of the buoyancy-driven kinetic energy generating device 9. Furthermore, when each bucket 921 is moved above the water surface and is about to sink into water again, a resistance occurs during sinking of the bucket 921. Furthermore, after each bucket 921 is in the water, the residual air in the bucket 921 generates buoyancy while the water is filling the bucket 921, causing further resistance to operation of the conveyor 92. In view of these factors, the buoyancy-driven kinetic energy generating device 9 not only consumes energy but must use a high-resistance mechanical structure with a resistance not larger than the total buoyancy. Thus, the buoyancy-driven kinetic energy generating 9 is in inefficient in generating kinetic energy.

In view of the above reasons, an improvement to the conventional buoyancy-driven kinetic energy generating device is necessary.

### SUMMARY OF THE INVENTION

An objective of the present invention is to provide a buoyancy-driven kinetic energy generating apparatus having increased total buoyancy while having a lower resistance during operation, allowing smooth operation of the buoyancy-driven kinetic energy generating apparatus to enhance the kinetic energy generating efficiency.

Another objective of the present invention is to provide a buoyancy-driven kinetic energy generating apparatus having a simple structure to reduce the costs of manufacture, assembly, and maintenance.

The present invention fulfills the above objectives by providing, in an aspect, a buoyancy-driven kinetic energy generating apparatus including a base having a tank. A rotor includes a rotor body and a shaft portion. The shaft portion is coupled to the rotor body and the tank. The rotor body is rotatably received in the tank about a rotating axis defined by the shaft portion. At least one float is mounted to the rotor body. The at least one float telescopes relative to the rotor body while the rotor body rotates about the rotating axis. A telescopic movement control module is mounted in the tank and controls the at least one float to telescope relative to the rotor body while the rotor body rotates.

In an example, the tank is adapted to receive a liquid. The rotor body has a hollow interior adapted to receive a mass having a density smaller than a density of the liquid to create buoyancy to float the rotor body on the liquid in the tank.

In another example, the tank is adapted to receive a liquid. The rotor body has a density smaller than a density of the liquid to create buoyancy to float the rotor body on the liquid in the tank.

Preferably, the base includes two shaft fixing portions. The shaft portion of the rotor body includes two shafts respectively mounted to the shaft fixing portions and coaxial to each other. Each shaft includes a shaft hole intercommunicating the interior of the rotor body with the outside of the tank.

In an example, the at least one float includes a first float. The first float moves relative to the rotor body while the first float rotates jointly with the rotor body about the rotating axis. The rotor body includes an outer surface. The first float is mounted to the outer surface of the rotor body. The first float telescopes relative to the outer surface of the rotor body while the first float and rotor body rotate jointly about the rotating axis.

Preferably, an outer surface of the first float is flush with the outer surface of the rotor body when the first float has a maximal retraction magnitude relative to the outer surface of the rotor body.

Preferably, the outer surface of the rotor body includes a peripheral face having a first slot. The first float includes a housing slideably received in the first slot. The housing of the first float has an opening facing an interior of the rotor body. The first float further includes an isolating member connecting the housing of the first float to the rotor body. The isolating member of the first float seals the first slot.

Preferably, the telescopic movement control module includes a control guiding member and a first balancing unit. The control guiding member is fixed to the tank. The first balancing unit is mounted between the rotor body and the first rotor and keeps the first float contacting the control guiding member.

Preferably, the first balancing member includes a first support seat fixed to an inner wall of the rotor body, a second support seat fixed to an inner wall of the housing, and an elastic returning member having two ends respectively pressing against the first support seat and the second support seat.

Preferably, the isolating member of the first float is made of an elastic leakproof material and includes a first end fixed to the peripheral face of the rotor body and a second end fixed to an outer face of the first float.

Preferably, the outer surface of the housing of the first float is arcuate and has a curvature corresponding to a curvature of the peripheral face of the rotor body.

Preferably, the housing of the first float further includes a liquid breaking portion in a front end of the housing in the rotating direction. The liquid breaking portion is V-shaped in cross section and includes two sides meeting at an edge and respectively connected to two lateral sides of the housing. The outer surface of the housing extends between the lateral sides of the housing.

In an example, the peripheral face is orthogonal to a movement plane perpendicular to the rotating axis. The control guiding member is annular and is mounted around the rotor body. The control guiding member includes a first maintaining section, a first movement control section, a second maintaining section, and a second movement control section in sequence. Each of the first maintaining section and the second maintaining section is connected between the first movement control section and the second movement control section. Each of the first movement control section and the second movement control section is connected between the first maintaining section and the second maintaining section. The control guiding member includes a continuous annular inner surface. An inner surface of the first maintaining section and an inner surface of the second maintaining section are concentric to the peripheral face of the rotor body. A radius of curvature of the first maintaining section in the movement plane is smaller than a radius of curvature of the second maintaining section in the movement plane. A spacing between an inner surface of the first movement control section and the rotating center of the rotor body in the movement plane increases from a connection end of the first movement control section connected to the first maintaining section towards another connection end of the first movement control section connected to the second maintaining section. A spacing between an inner surface of the second movement control section and the rotating center of the rotor body in the movement plane decreases from a connection end of the second movement control section connected to the second maintaining section towards another connection end of the second movement control section connected to the first maintaining section.

Preferably, the first float further includes a guiding member mounted on the outer surface of the housing. The guiding member has a roller. The roller contacts the continuous annular inner surface of the control guiding member to control telescopic movement of the first float. The isolating member of the first float is made of an elastic leakproof material. The first float has a minimal extension magnitude and the outer surface of the first float is flush with the peripheral face of the rotor body while the roller of the first float moves in the first maintaining section. The first float has a maximal extension magnitude while the roller of the first float moves in the second maintaining section. The extension magnitude of the first float increases gradually while the roller of the first float moves in the first movement control section. The extension magnitude of the first float decreases gradually while the roller of the first float moves in the second movement control section. The housing of the first float is located outside of the rotor body while the roller of the first float moves in the second maintaining section.

In another example, the at least one float further includes a plurality of second floats. The peripheral face of the rotor body further includes a plurality of second slots. Each of the plurality of second floats includes a housing slideably received in one of the plurality of second slots. The housing of each of the plurality of second floats has an opening facing the interior of the rotor body. The housing of each of the plurality of second floats further includes a roller mounted to an outer surface of the housing. Each of the plurality of second floats further includes an isolating member connecting the housing of the second float to the rotor body. The isolating member of each of the plurality of second floats seals one of the plurality of second slots. The telescopic movement control module further includes a plurality of second balancing units. Each of the second balancing units is mounted between the rotor body and one of the plurality of second floats to keep the rotor of the second float contacting the control guiding member. Each of the plurality of second floats has a minimal extension magnitude and the outer surface of the housing of the second float is flush with the peripheral face of the rotor body while the roller of the second float moves in the first maintaining section. Each of the plurality of second floats has a maximal extension magnitude while the roller of the second float moves in the second maintaining section. The extension magnitude of each of the plurality of second floats increases gradually while the roller of the second float moves in the first movement control section. The extension magnitude of each of the plurality of second floats decreases gradually while the roller of the second float moves in the second movement control section. The housing of each of the plurality of second floats located outside of the rotor body while the roller of the second float moves in the second maintaining section.

Preferably, the first float and the plurality of second floats are spaced from each other at regular intervals.

In a further example, the peripheral face is orthogonal to a movement plane perpendicular to the rotating axis and the at least one float further includes a second float. The first and second floats are opposite to each other in a diametric direction of the rotor body. The peripheral face of the rotor body further includes a second slot. The second float includes a housing slideably received in the second slot. The housing of the second float has an opening facing the interior of the rotor body. The second float further includes an isolating member connecting the housing of the second float to the rotor body. The isolating member of the second float seals the second slot. The telescopic movement control module surrounds a portion of the outer surface of the rotor body. The telescopic movement control module controls telescopic movement of at least one of the first and second floats and synchronously moves the first and second floats relative to the rotor body.

Preferably, the telescopic movement control module further includes a connecting module connected between the first and second floats. The connecting module includes two fixing members respectively fixed to inner walls of the housings of the first and second floats. The connecting module further includes a connecting rod having two ends respectively fixed to the fixing members.

Preferably, the telescopic movement control module includes a pressing board. The pressing board includes a movement control section and a maintaining section following the movement control section in a rotating direction of the rotor body. A spacing between the movement control section and the rotating center of the rotor in the movement plane decreases from a point of the movement control section toward the maintaining section. An inner surface of the maintaining section is concentric to the peripheral face of the rotor body.

In still another example, the telescopic movement control module includes two rails. Each rail is arcuate and is parallel to and spaced from each other, forming a passage between the rails. Each rail includes a movement control section and a maintaining section following the movement control section in a rotating direction of the rotor body. A spacing between an outer surface of the movement control section of each rail to the rotating center of the rotor body in the movement plane increases from a point of the movement control section toward a connection between the movement control section and the maintaining section. An outer surface of the maintaining section of each rail is concentric to the peripheral face of the rotor body.

Preferably, the second float includes a housing slideably received in the second slot. The housing of each of the first and second floats includes a guiding member mounted on the outer surface of the housing. The guiding member of each of the first and second floats has a roller. The roller of the first float or the second float moves through the passage and contacts outer surfaces of the maintaining sections and the movement control sections of the rails when the first float or the second float moves through the rails.

In yet another example, the peripheral face of the rotor body further includes a third slot and a fourth slot. The at least one float further includes a third float and a fourth float diametrically opposed to the third float. Each of the third and fourth floats is located between the first and second floats. The third float includes a housing slideably received in the third slot. The housing of the third float has an opening facing the interior of the rotor body. The third float further includes an isolating member connecting the housing of the third float to the rotor body. The isolating member of the third float seals the third slot. The fourth float includes a housing slideably received in the fourth slot. The housing of the fourth float has an opening facing the interior of the rotor body. The fourth float further includes an isolating member connecting the housing of the fourth float to the rotor body. The isolating member of the fourth float seals the fourth slot. The housing of each of the third and fourth floats includes a guiding member mounted on the outer surface of the housing. The guiding member of each of the third and fourth floats has a roller. The roller of the third float or the fourth float moves through the passage and contacting outer surfaces of the maintaining sections and the movement control sections of the rails while the third float or the fourth float moves through the rails.

Preferably, the rotor body further includes a plurality of outer tracks and a ring connecting the plurality of outer tracks. The plurality of outer tracks is connected to the rotor body. Each of the first, second, third, and fourth floats includes a limiting member slideably mounted in one of the plurality of outer tracks.

Preferably, the isolating member of each of the first, second, third, and fourth floats is made of an elastic leakproof material and includes a first end fixed to the peripheral face of the rotor body and a second end fixed to an outer face of one of the first, second, third, and fourth floats.

Preferably, the outer surface of the housing of each of the first, second, third, and fourth floats is arcuate and has a curvature corresponding to a curvature of the peripheral face of the rotor body.

Preferably, the housing of each of the first, second, third, and fourth floats further includes a liquid breaking portion in a front end of the housing in the rotating direction. The liquid breaking portion is V-shaped in cross section and includes two sides meeting at an edge and respectively connected to two lateral sides of the housing. The outer surface of the housing extends between the lateral sides of the housing.

In another aspect, a method is provided for generating kinetic energy using the buoyancy-driven kinetic energy generating apparatus. The method includes filling a liquid into the tank to provide the rotor body with a pre-buoyancy and controlling the float to telescope relative to the rotor body, causing a change in local buoyancy of the rotor body to imbalance the rotor body and to cause rotation of the rotor body about a rotating axis. The float completes a telescopic cycle while the float rotates a turn together with the rotor body about the rotating axis. The telescopic cycle includes a float hidden stroke, a float gradual extending stroke, a float completely exposed stroke, and a float gradual retracting stroke in sequence. The tank includes a float hidden section, a float gradual extending section, a float completely exposed section, and a float gradual retracting section in sequence in a rotating direction of the rotor body. The float hidden section, the float gradual extending section, the float completely exposed section, and the float gradual retracting section correspond to the float hidden stroke, the float gradual extending stroke, the float completely exposed stroke, and the float gradual retracting stroke, respectively.

The float maintains in a maximal retraction state having a maximal retraction magnitude when located in the float hidden section. When the float is driven by the rotating rotor body to move from the float hidden section into the float gradual extending section, the float undergoes the float gradual extending stroke, and the extension magnitude of the float increases gradually until the float enters the float completely exposed section where the extension magnitude of the float is maximal. The float undergoes the float completely exposed stroke in the float completely exposed section and maintains the maximal extension magnitude to drive the rotor body to rotate. The float is driven by the rotating rotor body to move from the float completely exposed section into the float gradual retracting section. The float undergoes the float gradual retracting stroke, and the extension magnitude of the float decreases gradually in the float gradual retracting section until the float enters the float hidden section and then undergoes the float hidden stroke in the maximal retraction state.

Preferably, the float gradual extending section is located below a level of the liquid, and the float gradual retracting section is located above the level of the liquid.

Preferably, the float hidden section is opposite to the float completely exposed section in a diametric direction of the rotor body, the float gradual extending section is opposite to the float gradual retracting section in a diametric direction of the rotor body, and the float hidden section, the float gradual extending section, the float completely exposed section, and the float gradual retracting section extending through a same angle.

In an example, the at least one float further includes a first float and a second float opposed to the first float in a diametric direction of the rotor body. One of the first and second floats undergoes the float hidden stroke while the other of the first and second floats undergoes the float completely exposed stroke. One of the first and second floats undergoes the float gradual extending stroke while the other of the first and second floats undergoes the float gradual retracting stroke.

Preferably, the extension magnitude of the at least one float forms an arcuate path during the float gradual extending stroke, the float completely exposed stroke, and the float gradual retracting stroke. In an example, the extension magnitude of the at least one float forms an arcuate path having increasing radiuses of curvature along with rotational movement of the rotor body about the rotating axis during the float gradual extending stroke, the extension magnitude of the at least one float forms an arcuate path having a uniform radius of curvature along with the rotational movement of the rotor body during the float completely exposed stroke, and the extension magnitude of the at least one float forms an arcuate path having decreasing radiuses of curvature along with the rotational movement of the rotor body during the float gradual retracting stroke.

Thus, the buoyancy-driven kinetic energy generating apparatus has increased total buoyancy and has a lower resistance during operation, allowing smooth operation of the buoyancy-driven kinetic energy generating apparatus to enhance the kinetic energy generating efficiency. Furthermore, the buoyancy-driven kinetic energy generating apparatus has a simple structure to reduce the costs of manufacture, assembly, and maintenance.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a schematic view of a conventional buoyancy-driven kinetic energy generating device.

FIG. 2 is a perspective view of a buoyancy-driven kinetic energy generating apparatus of a first embodiment according to the present invention, with a portion of the buoyancy-driven kinetic energy generating apparatus cut away.

FIG. 3 is a cross sectional view of the buoyancy-driven kinetic energy generating apparatus of the first embodiment according to the present invention.

FIG. 4 is a partial, exploded perspective view of a float of the first embodiment according to the present invention.

FIG. 5 is an enlarged view of a portion of the float according to the present invention, with the float in an extended position, and with an isolating member unstretched.

FIG. 6 is an enlarged view of the portion of the float according to the present invention, with the float in a retracted position, and with the isolating member stretched.

FIG. 7 is a schematic diagram illustrating the extension magnitude of the float when a rotor according to the present invention rotates in a clockwise direction.

FIG. 8 is a first operational state of the first embodiment according to the present invention having a single float.

FIG. 9 is a second operational state of the first embodiment according to the present invention having a single float.

FIG. 10 is a third operational state of the first embodiment according to the present invention having a single float.

FIG. 11 is a fourth operational state of the first embodiment according to the present invention having a single float.

FIG. 12 is a first operational state of the first embodiment according to the present invention having three floats.

FIG. 13 is a second operational state of the first embodiment according to the present invention having three floats.

FIG. 14 is a third operational state of the first embodiment according to the present invention having three floats.

FIG. 15 is a partial, exploded, perspective view of a buoyancy-driven kinetic energy generating apparatus of a second embodiment according to the present invention.

FIG. 16 is a first operational state of the second embodiment according to the present invention having two floats.

FIG. 17 is a partial, side view of one of the floats of the second embodiment according to the present invention, with the float extending and retracting under guidance of two tracks.

FIG. 18 is a second operational state of the second embodiment according to the present invention having two floats.

FIG. 19 is a third operational state of the second embodiment according to the present invention having two floats.

FIG. 20 is a fourth operational state of the second embodiment according to the present invention having two floats.

FIG. 21 is a first operational state of a buoyancy-driven kinetic energy generating apparatus of a third embodiment according to the present invention having two floats.

FIG. 22 is a first operational state of a buoyancy-driven kinetic energy generating apparatus of a fourth second embodiment according to the present invention having four floats.

FIG. 23 is a second operational state of the fourth embodiment according to the present invention having four floats.

FIG. 24 is an operational state of a buoyancy-driven kinetic energy generating apparatus of a fifth embodiment according to the present invention having four floats.

FIG. 25 is a schematic diagram illustrating the extension magnitude of the float when a rotor according to the present invention rotates in a counterclockwise direction.

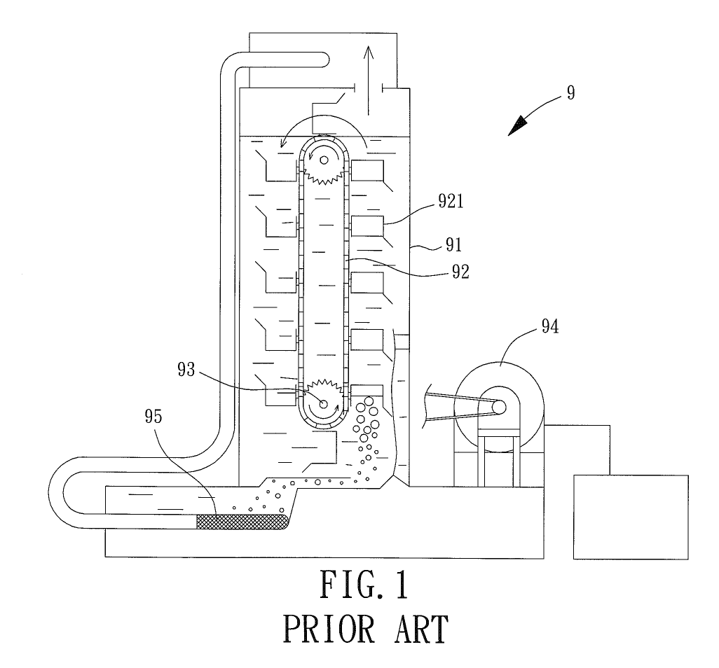

### DETAILED DESCRIPTION OF THE INVENTION

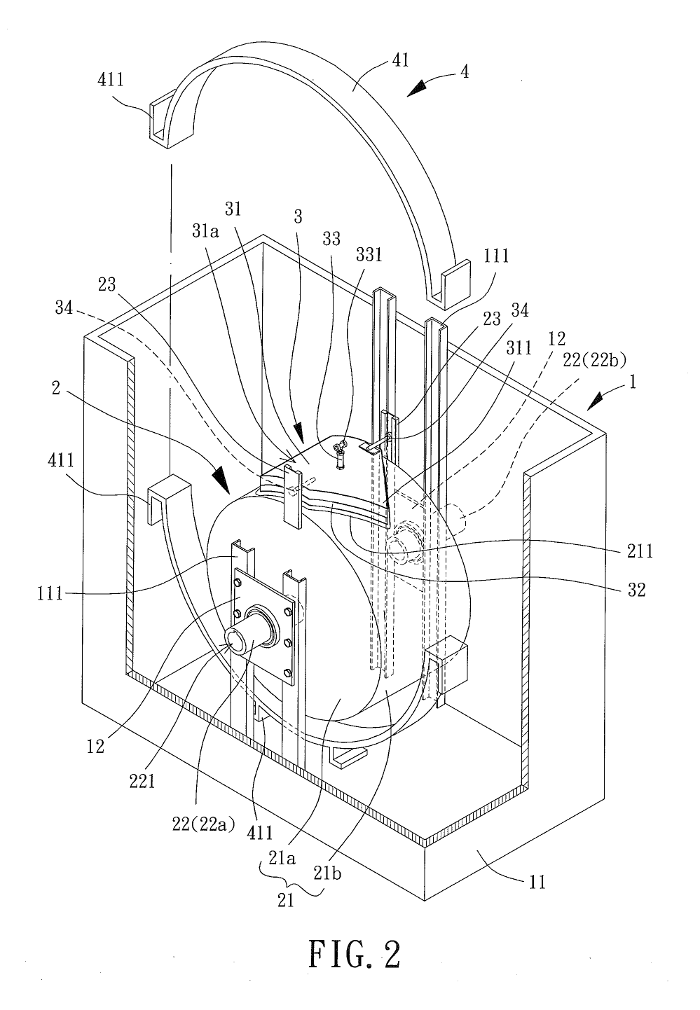

FIG. 2 shows a buoyancy-driven kinetic energy generating apparatus of a first embodiment according to the present invention. The buoyancy-driven kinetic energy generating apparatus generally includes a base 1, a rotor 2, a float 3, and a telescopic movement control module 4. The rotor 2 is rotatably mounted to the base 1. The float 3 is telescopically mounted to the rotor 2. The telescopic movement control module 4 is mounted to the base 1 to control telescopic movement of the float 3 relative to the rotor 2.

The base 1 is adapted to receive a flowable working medium, such as a liquid. The base 1 also provides assembling and positioning for the rotor 2 and the telescopic movement control module 4. Specifically, the base 1 includes a tank 11 receiving the liquid and two shaft fixing portions 12. The shaft fixing portions 12 are respectively mounted to two opposite outer sides of the tank 11 respectively of two lateral walls of the tank 11. In this embodiment, each shaft fixing portion 12 is a board with a bearing. Furthermore, a support 111 is mounted to each outer side of the tank 11, and a shaft fixing portion 12 is assembled and fixed to one of the outer sides of the tank 11 via one of the supports 111. Leakage-proof gaskets (not shown) can be mounted between the tank 11 and the shaft fixing portions 12 to prevent leakage of the liquid, such that a portion of the rotor 2 can extend through the lateral walls of the tank 11 without liquid leakage.

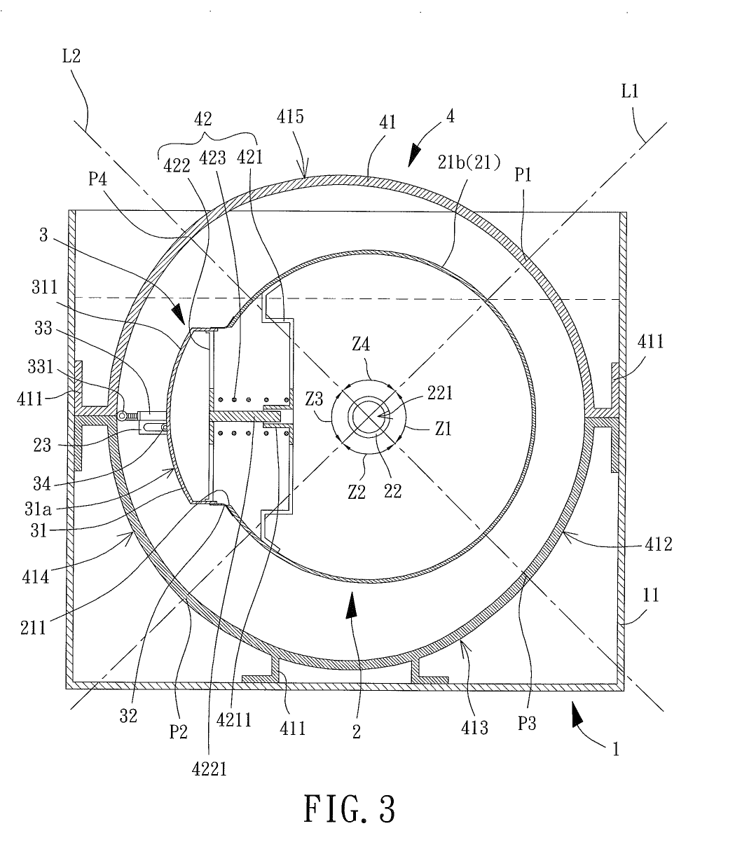

With reference to FIGS. 2 and 3, the rotor 2 is rotatably mounted to the base 1. Specifically, the rotor 2 includes a rotor body 21 and a shaft portion 22. The rotor body 21 includes a hollow interior for receiving a mass having a density smaller than a density of the liquid received in the tank 11. The mass can be a gas or a solid (such as expandable polystyrene or low-density wood). Alternatively, the rotor body 21 can be directly made of a low-density solid, and the liquid received in the tank 11 can provide sufficiency buoyancy to make the rotor body 21 float. In this embodiment, the rotor body 21 is in the form of a cylindrical housing having a hollow interior such that the easiest-to-obtain air can directly be contained in the interior of the rotor body 21 to reduce the costs. The rotor body 21 includes two opposite end faces 21a and a peripheral face 21b connected between the end faces 21a. A plurality of slots 211 is defined in the peripheral face 21b. The number of the slots 211 corresponds to that of the floats 3.

The shaft portion 22 of the rotor 2 extends through the end faces 21a of the rotor body 21 to connect the shaft fixing portions 12 of the base 1, allowing the rotor body 21 to be received in the tank 11 and to rotate in the tank 11 about a rotating axis defined by the shaft portion 22 and passing a rotating center of the rotor body 21. In this embodiment, the shaft portion 22 includes two coaxially located shafts 22a and 22b, with each shaft 22a, 22b having a shaft hole 221. Each shaft 22a, 22b includes an end mounted to one of the end faces 21a of the rotor body 21. The other end of each shaft 22a, 22b extends through the tank 11 and is connected to one of the shaft fixing portions 12. Thus, the interior of the rotor body 21 intercommunicates with the outside of the tank 11 via the shaft holes 221. By such an arrangement, the rotor body 21 of the rotor 2 can rotate in the tank 11 relative to the base 1 while the interior of the rotor body 21 is empty for receiving other components to reduce limitation to the spatial arrangement of the components. Furthermore, the overall weight of the rotor 2 can be reduced to increase convenience during assembly. Furthermore, the shaft portion 22 can be in the form of a single shaft extending through the rotor body 21 while allowing the rotor body 21 to rotate in the tank 11 relative to the base 1, which can be appreciated and can be modified by one having ordinary skill in the art. The present invention is not limited to the embodiment shown. Furthermore, the rotor 2 can include a plurality of outer tracks 23 respectively mounted to the end faces 21a of the rotor body 21 (namely, the plurality of outer tracks 23 is connected to the rotor body 21) to guide the telescopic movement of the float 3.

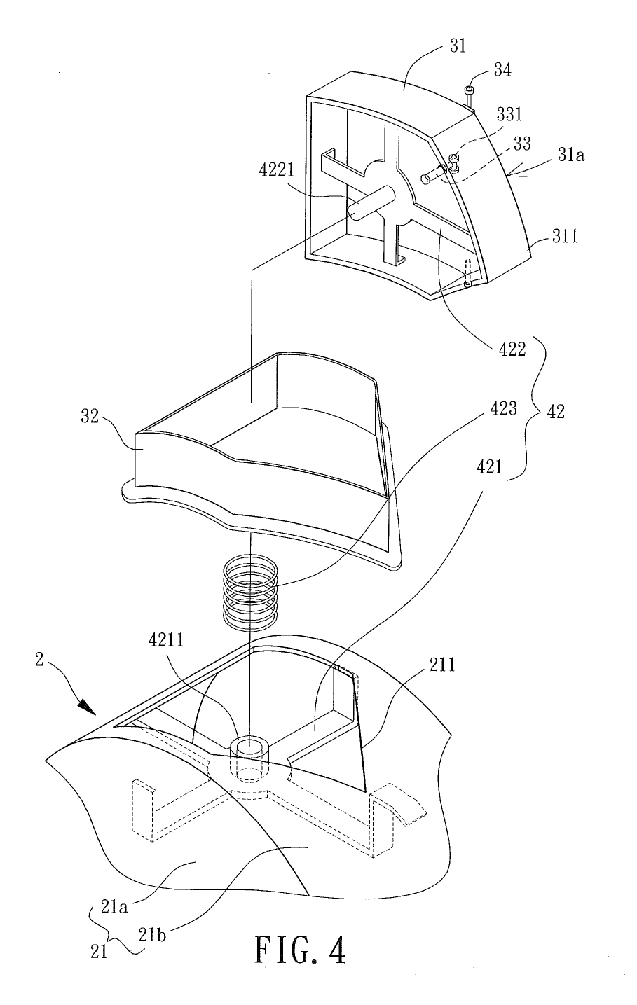

The float 3 is telescopically mounted to the rotor body 21. In the embodiment shown in FIGS. 2 and 3, the float 3 is mounted to the peripheral face 21b of the rotor body 21 to telescopically move in a radial direction of the rotor body 21 perpendicular to the rotating axis of the rotor body 21. Specifically, with reference to FIGS. 3 and 4, the float 3 includes a housing 31 and an isolating member 32. An interior of the housing 31 provides a space with a predetermined volume. The housing 31 has an open end. When the housing 31 is mounted in the slot 211 of the rotor body 21, the open end of the housing 31 faces the interior of the rotor body 21. Furthermore, the housing 31 is connected to the rotor body 21 via the isolating member 32 to assure that the interior space of the rotor body 21 is isolated from the liquid in the tank 11.

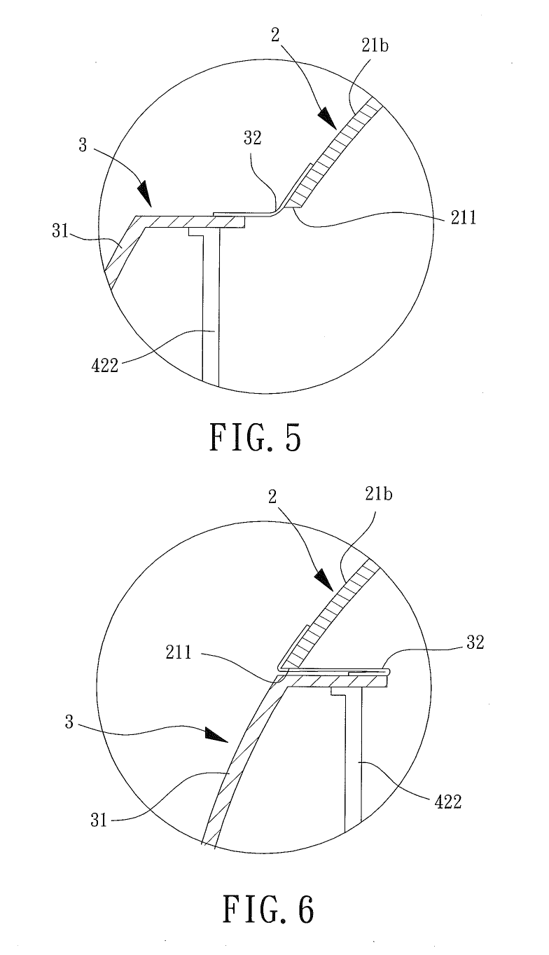

In this embodiment, the isolating member 32 is made of an elastic leakproof material. An end of the isolating member 32 is fixed to the peripheral face 21b of the rotor body 21. The other end of the isolating member 32 is fixed to an outer face of the housing 31 such that the liquid in the tank 11 will not leak into the housing 31 and the rotor body 21. Furthermore, the connection between the isolating member 32 and the rotor body 21 is gapless and can be achieved by, for example, gluing, and several fasteners (not shown) can be provided tighten the isolating member 32 and the rotor body 21 to increase the engagement reliability. By such an arrangement, with reference to FIG. 5, when the float 3 is in an unretracted state (or is extending) relative to the peripheral face 21b of the rotor body 21, the isolating member 32 is in an unstretched state (or gradually returns to the unstretched state). On the other hand, with reference to FIG. 6, when the float 3 retracts relative to the peripheral face 21b of the rotor body 21, the isolating member 32 can be continuously stretched and undergo elastic deformation. Thus, the magnitude of the telescopic movement of the housing 31 of the float 3 relative to the rotor body 21 can be increased by the isolating member 32.

Still referring to FIGS. 3 and 4, the outer surface 31a of the housing 31 can be arcuate and preferably has a curvature corresponding to a curvature of the peripheral face 21b of the rotor body 21. Thus, when the housing 31 retracts into the interior of the rotor body 21, the outer surface 31a of the housing 31 and the peripheral face 21b of the rotor body 21 can form a continuous arcuate face to reduce the resistance while entering the liquid. The housing 31 further includes a liquid breaking portion 311 in a front end of the housing 31 in the rotating direction. The liquid breaking portion 311 is V-shaped in cross section and includes two sides meeting at an edge and respectively connected to two lateral sides of the housing 31. The outer surface 31a of the housing 31 extends between the lateral sides of the housing 31. The liquid breaking portion 311 reduces the resistance when the float 3 floats upward and increases the floating speed. Furthermore, the float 3 further includes a guiding member 33 and a plurality of limiting member 34 on the outer surface 31a of the housing 31. Preferably, the length of the guiding member 33 is adjustable. A roller 331 is mounted to a free end of the guiding member 33. When the guiding member 33 contacts the telescopic movement control module 4, the roller 331 smoothly and continuously moves on the telescopic movement control module 4. The limiting members 34 can be located adjacent to two lateral edges of the outer surface 31a of the housing 31 and are respectively restrained in the outer tracks 23, such that the housing 31 are restricted and can only move along a guiding direction provided by the outer tracks 23.

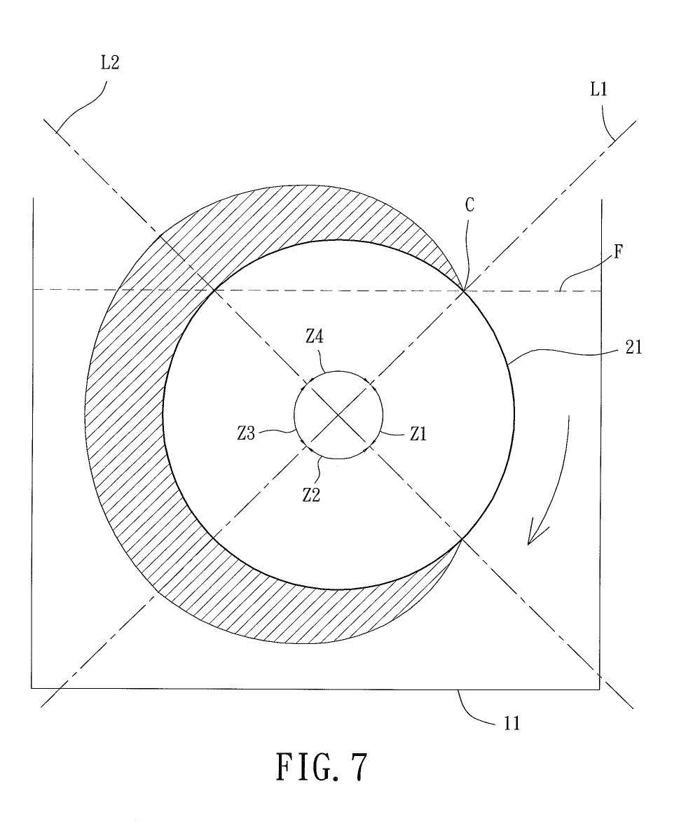

The guiding member 33 of the float 3 moves in a movement plane (see FIGS. 3 and 7) while the float 3 rotates jointly with the rotor body 21 about the rotating axis defined by the shaft portion 22 and passing through the rotating center of the rotor body 21. The movement plane extends through the rotating center of the rotor body 21 and extends perpendicularly to the rotating axis of the rotor body 21. Unless indicated otherwise, the definitions relating to spacings, radiuses, lines L1 and L2, connections P1, P2, P3, and P4, and sections Z1, Z2, Z3, and Z4 are made in reference to the movement plane. Namely, the lines L1 and L2, the connections P1, P2, P3, and P4, and the sections Z1, Z2, Z3, and Z4 are located on the movement plane, and the spacing or radius is also calculated based on the distance between the rotating center of the rotor body 21 and the curvature of a portion of a component on the movement plane. Note that the peripheral face 21b of the rotor body 21 is orthogonal to the movement plane perpendicular to the rotating axis.

With reference to FIGS. 2, 3, and 4, the telescopic movement control module 4 is mounted in the tank 11 of the base 1 to control the telescopic movement of the float 3 relative to the rotor body 21 during rotation of the rotor body 21. In this embodiment, the telescopic movement control module 4 includes a control guiding member 41 and a balancing unit 42. The control guiding member 41 is mounted to an inner wall of the tank 11. The balancing unit 42 is mounted between the float 3 and the rotor body 21 to actuate the float 3. The balancing unit 42 balances forces imparted to the inner and outer sides of the float 3, maintaining contact between the float 3 and the control guiding member 41.

Specifically, the control guiding member 41 is substantially a ring and includes a plurality of fixing members 411 fixed to the inner wall of the tank 11 such that the control guiding member 41 is received in the tank 11 and surrounds the rotor body 21. To increase the assembling convenience, the control guiding member 41 can be comprised of a plurality of arcuate boards coupled to each other, with the arcuate boards having the same or different lengths, which can be modified by one having ordinary skill in the art according to needs. The present invention is not limited to the embodiment shown.

The control guiding member 41 includes a first maintaining section 412, a first movement control section 413, a second maintaining section 414, and a second movement control section 415, with the first maintaining section 412, the first movement control section 413, the second maintaining section 414, and the second movement control section 415 connected to each other in sequence. The second movement control section 415 is connected to the first maintaining section 412. Namely, each of the first maintaining section 412 and the second maintaining section 414 is connected between the first movement control section 413 and the second movement control section 415, and each of the first movement control section 413 and the second movement control section 415 is connected between the first maintaining section 412 and the second maintaining section 414. Thus, the control guiding member 41 includes a continuous, closed, annular inner surface. The inner surface of the first maintaining section 412 and the inner surface of the second maintaining section 414 are concentric to the peripheral face 21b of the rotor body 21. A radius of curvature of the first maintaining section 412 is smaller than a radius of curvature of the second maintaining section 414.

A spacing between the inner surface of the first movement control section 413 and the rotating center of the rotor body 21 increases from a connection end of the first movement control section 413 connected to the first maintaining section 412 towards another connection end of the first movement control section 413 connected to the second maintaining section 414. A spacing between the inner surface of the second movement control section 415 and the rotating center of the rotor body 21 decreases from a connection end of the second movement control section 415 connected to the second maintaining section 414 towards another connection end of the second movement control section 415 connected to the first maintaining section 412.

The first maintaining section 412 is connected to the second movement control section 415 at a connection P1. The first movement control section 413 is connected to the second maintaining section 414 at a connection P2. A line section passing through the connection P1 and the rotating center of the rotor body 21 and another line section passing through the connection P2 and the rotating center of rotor body 21 together define a telescopic movement end line L1. Preferably, the connections P1 and P2 are opposed to each other in a diametric direction of the rotor body 21 such that the telescopic movement end line L1 is rectilinear.

Furthermore, the first maintaining section 412 is connected to the first movement control section 413 at a connection P3. The second maintaining section 414 is connected to the second movement control section 415 at a connection P4. A line section passing through the connection P3 and the rotating center of the rotor body 21 and another line section passing through the connection P4 and the rotating center of rotor body 21 together define a telescopic movement start line L2. Preferably, the connections P3 and P4 are opposed to each other in a diametric direction of the rotor body 21 such that the telescopic movement start line L2 is rectilinear. Furthermore, the telescopic movement end line L1 is orthogonal to the telescopic movement start line L2.

With reference to FIGS. 3 and 4, the balancing unit 42 includes a first support seat 421, a second support seat 422, and an elastic returning member 423. The first support seat 421 is fixed to an inner wall of the rotor body 21. The second support seat 422 is fixed to an inner wall of the housing 31 of the float 3. Furthermore, the second support seat 422 is movable relative to the first support seat 421 in a radial direction of the rotor body 21. As an example, the first support seat 421 includes a sleeve 4211. The second support seat 422 includes an axle 4221 slideably received in the sleeve 4211. Alternatively, the axle 4221 can be provided on the first support seat 421, and the sleeve 4211 can be provided on the second support seat 422.

The elastic returning member 423 is a member with elastic deforming capacity, such as a spring or a resilient plate. Two ends of the elastic returning member 423 respectively press against the first support seat 421 and the second support seat 422 to balance the forces exerted on the inner and outer sides of the float 3. When the float 3 is pushed by the control guiding member 41, the elastic returning member 423 presses against the second support seat 422 such that the float 3 keeps contacting the control guiding member 41. On the other hand, when the float 3 is pulled by the control guiding member 41, the elastic returning member 423 pulls the second support seat 422 such that the float 3 keeps contacting the control guiding member 41. In this embodiment, the elastic returning member 423 is in the form of a compression spring mounted around the sleeve 4211. The sleeve 4211 assures that the elastic returning member 423 merely has axial deformation. In other embodiments, the balancing unit 42 can include electrically controlled components or hydraulic or pneumatic cylinder components for actuating the float 3.

Please refer reference to FIG. 3 and FIG. 7. FIG. 7 is a schematic diagram illustrating the extension magnitude of the float 3 when the rotor 2 according to the present invention rotates in a clockwise direction. The hatching area in FIG. 7 indicates the extension magnitude of the float 3 in the tank 11. When the buoyancy-driven kinetic energy generating apparatus operates, the float 3 completes a telescopic cycle relative to the peripheral face 21b of the rotor body 21 while the float 3 rotates a round together with the rotor body 21. Each telescopic cycle includes four strokes: a float hidden stroke, a float gradual extending stroke, a float completely exposed stroke, and a float gradual retracting stroke. The float 3 maintains in a state having the maximal retraction magnitude (i.e., the extension magnitude is minimal) during the float hidden stroke. The extension magnitude of the float 3 increases gradually during the float gradual extending stroke. The float 3 maintains in a state having the maximal extension magnitude during the float completely exposed stroke. The extension magnitude of the float 3 gradually decreases during the float gradual retracting stroke. The float 3 has the maximal retraction magnitude when the float 3 returns to the float hidden stroke.

The telescopic movement end line L1 and the telescopic movement start line L2 divide the movement plane into four sections (starting from the telescopic movement end line L1 in the rotating direction of the rotor 2): a float hidden section Z1, a float gradual extending section Z2, a float completely exposed section Z3, and a float gradual retracting section Z4. The float hidden section Z1, the float gradual extending section Z2, the float completely exposed section Z3, and the float gradual retracting section Z4 respectively correspond to the float hidden stroke, the float gradual extending stroke, the float completely exposed stroke, and the float gradual retracting stroke. Namely, the float hidden section Z1, the float gradual extending section Z2, the float completely exposed section Z3, and the float gradual retracting section Z4 respectively correspond to the first maintaining section 412, the first movement control section 413, the second maintaining section 414, and the second movement control section 415 of the control guiding member 41, such that the float 3 can undergo the float hidden stroke, the float gradual extending stroke, the float completely exposed stroke, and the float gradual retracting stroke. The space in the tank 11 is also divided into four sectors (corresponding to the four sections Z1-Z4) by a first plane and a second plane. The first plane includes the telescopic movement end line L1 and extends perpendicularly to the movement plane. The second plane includes the telescopic movement start line L2, extends perpendicularly to the movement plane, and is orthogonal to the first plane.

Furthermore, the liquid contained in the tank 11 preferably has a level F at the upper portion of the rotor body 21 where the telescopic movement end line L1 passes the rotor body 21 (see point C in FIG. 7), such that the float gradual extending section Z2 is located below the level F and such that the float gradual retracting section Z4 is located above the level F. This assures that when the float 3 enters the float gradual retracting section Z4, the float 3 can smoothly retract into the interior of the rotor body 21 in the air without resistance caused by the liquid and can enter the liquid in the maximal retraction state. The resistance to the rotation of the rotor body 21 at the moment the float 3 entering the liquid and affected by the liquid resistance can be reduced, enhancing the overall kinetic energy generating efficiency of the buoyancy-driven kinetic energy generating apparatus.

By such an arrangement, the float hidden stroke of the float 3 corresponds to the float hidden section Z1 and maintains the maximal retraction magnitude (i.e., the minimal extension magnitude). When the float 3 is driven by the rotating rotor body 21 to move from the float hidden section Z1 into the float gradual extending section Z2, the float 3 undergoes the float gradual extending stroke, and the extension magnitude of the float 3 increases gradually until the float 3 enters the float completely exposed section Z3 where the extension magnitude of the float 3 is maximal. The float 3 undergoes the float completely exposed stroke in the float completely exposed section and maintains its maximal extension magnitude to drive the rotor body 21 to rotate. The float 3 is driven by the rotating rotor body 21 to move from the float completely exposed section Z3 into the float gradual retracting section Z4. Next, the float 3 undergoes the float gradual retracting stroke, and the extension magnitude of the float decreases gradually in the float gradual retracting section Z4 until the float 3 enters the float hidden section Z1 and then undergoes the float hidden stroke in its maximal retraction state.

Accordingly, the extension magnitude of the float 3 (the travel of the roller 331) of the present invention forms an arcuate path during the float gradual extending stroke, the float completely exposed stroke, and the float gradual retracting stroke. The arcuate path effectively reduces the rotational resistance to the rotor body 21 and maintains smooth rotation of the rotor body 21. In this embodiment, during the float gradual extending stroke of the float 3, the extension magnitude of the float 3 (the travel of the roller 331) forms an arcuate path having increasing radiuses of curvature along with the rotational movement of the rotor body 21. During the float completely exposed stroke of the float 3, the extension magnitude of the float 3 (the travel of the roller 331) forms an arcuate path having a uniform radius of curvature along with the rotational movement of the rotor body 21. During the float gradual retracting stroke of the float 3, the extension magnitude of the float 3 (the travel of the roller 331) forms an arcuate path having decreasing radiuses of curvature along with the rotational movement of the rotor body 21.

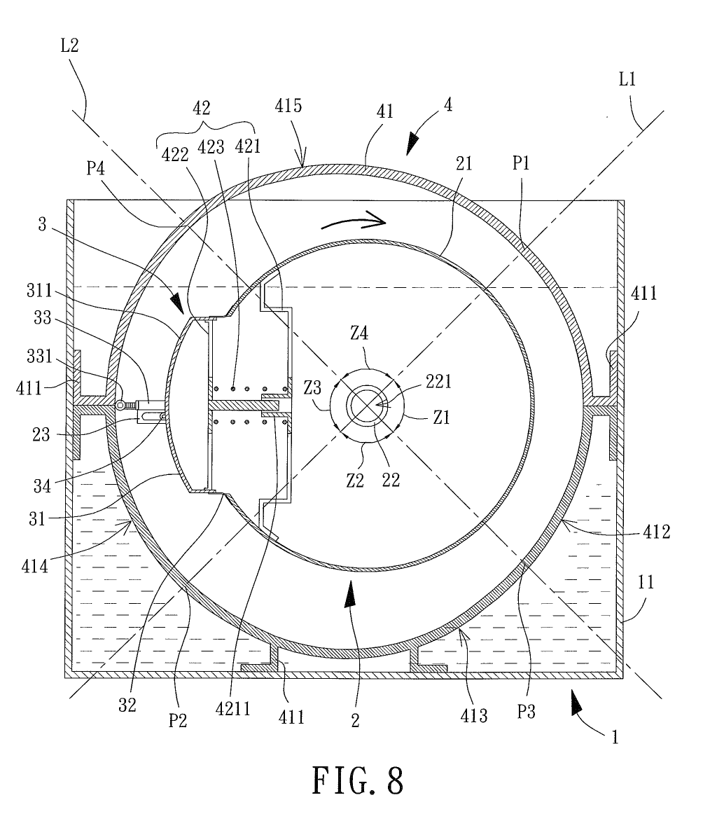

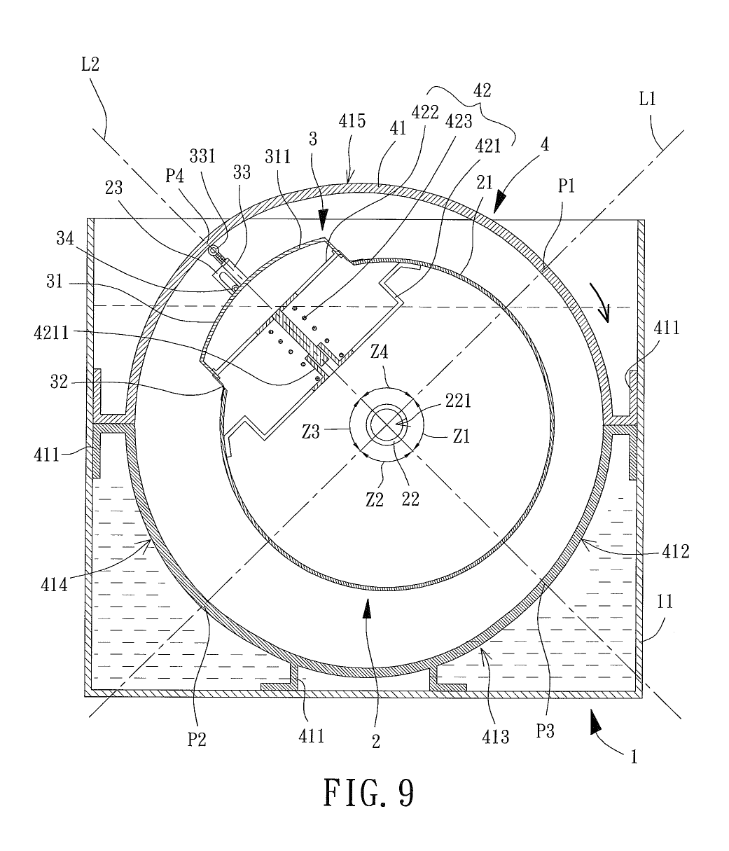

With reference to FIG. 8, in the buoyancy-driven kinetic energy generating apparatus of the first embodiment according to the present invention, when the tank 11 has not been filled with a sufficient amount of liquid, the float 3 can be set to be located in the float completely exposed section Z3, and the balancing unit 42 presses against the housing 31, such that the roller 331 of the guiding member 33 of the float 3 contacts the second maintaining section 414 of the control guiding member 41, with the float 3 in the maximal extension state. When the tank 11 is filled with a sufficient amount of liquid, the rotor body 21 can create a great pre-buoyancy in the liquid. At the same time, since the density of the air in the interior space of the housing 31 is smaller than the density of the liquid in the tank 11, the float 3 in the float completely exposed section Z3 and having the maximal extension magnitude additionally and locally increases the buoyancy of the rotor body 21 to imbalance the rotor body 21. As a result, the rotor body 21 starts to rotate.

With reference to FIG. 9, after the float 3 rotates jointly with the rotor body 21 and passes through the connection P4 between the second maintaining section 414 and the second movement control section 415, the control guiding member 41 starts to push the float 3 by the second movement control section 415 to make the float 3 undergo the float gradual retracting stroke, gradually reducing the extension magnitude of the float 3 and gradually retracting the float 3 into the interior of the rotor body 21. The rotor body 21 continues its rotation, and the float 3 emerges from the liquid to a position above the level F while the float enters the float gradual retracting section Z4 in which the float 3 continuously retracts into the interior of the rotor body 21. The liquid breaking portion 311 of the float 3 assists in reducing the resistance of the housing 31 moving in the liquid, increasing the rotational movement of the rotor body 21 carrying the float 3 while reducing unnecessary loss of the kinetic energy to enhance the efficacy of the buoyancy-driven kinetic energy generating apparatus.

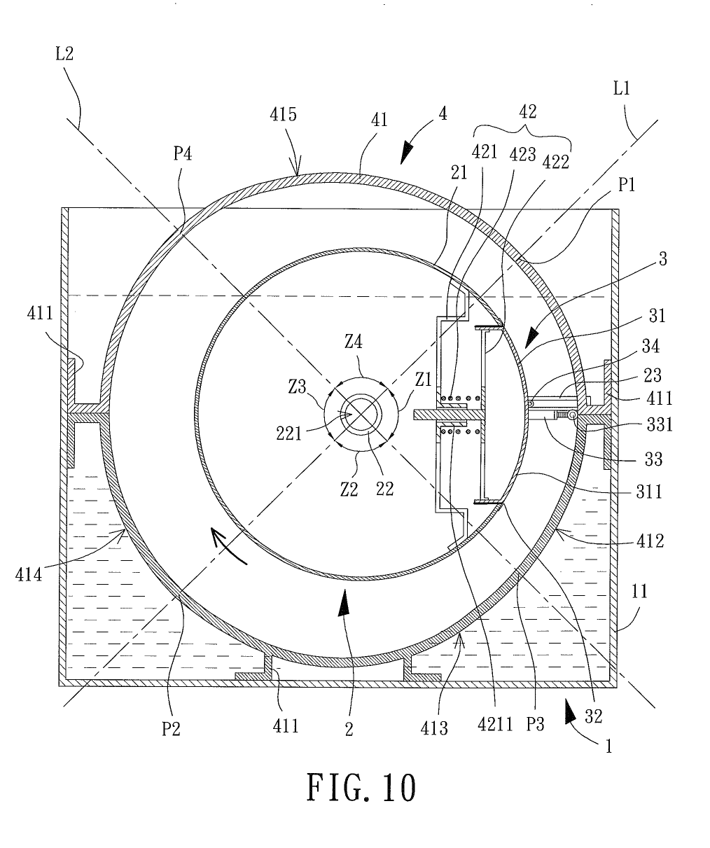

With reference to FIG. 10, the float 3 rotates jointly with the rotor body 21 and is gradually compressed to reduce the extension magnitude until the float 3 moves to the connection P1 between the second movement control section 415 and the first maintaining section 412. Since the float 3 at the connection P1 has the maximal retraction magnitude, the float 3 reenters the liquid with the minimal resistance and enters the float hidden section Z1. In the float hidden section Z1, the control guiding member 41 stops pushing the float 3, and the first maintaining section 412 of the control guiding member 41 keeps the float 3 in the state having the maximal retraction magnitude.

After the float 3 rotates jointly with the rotor body 21 and passes the connection P3 between the first maintaining section 412 and the first movement control section 413, the balancing unit 42 presses against the housing 31 of the float 3 to keep the roller 331 of the guiding member 33 of the float 3 contacting the first movement control section 413 of the control guiding member 41. Then, the float 3 undergoes the float gradual extending stroke, and the extension magnitude of the float 3 beyond the outer surface of the rotor body 21 increases gradually in the float gradual extending section Z2. Thus, the buoyancy is gradually increased to assist in rotation of the rotor body 21.

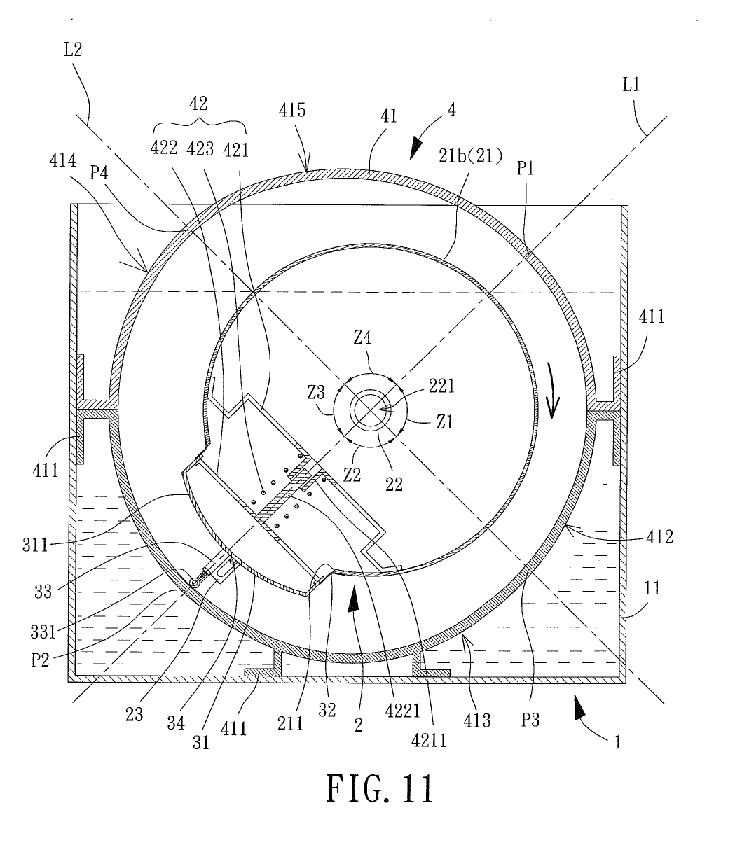

With reference to FIG. 11, finally, the float 3 rotates jointly with the rotor body 21 and passes through the connection P2 between the first control movement section 413 and the second maintaining section 414. Then, the float 3 reenters the float completely exposed section Z3, completing a telescopic cycle.

In brief, in the buoyancy-driven kinetic energy generating apparatus of the first embodiment according to the present invention, the balancing unit 42 keeps the float 3 contacting the control guiding member 41, and the float 3 telescopes relative to the rotor body 21 under the guidance by the first maintaining section 412, the first movement control section 413, the second maintaining section 414, and the second movement control section 415 to finish the float hidden stroke, the float gradual extending stroke, the float completely exposed stroke, and the float gradual retracting stroke in a telescopic cycle, providing assistance in rotation of the rotor body 21. By such arrangement, when the shaft portion 22 of the rotor body 21 is connected to a generator or a device directly driven by shaft work, the buoyancy-driven kinetic energy generating apparatus according to the present invention can use buoyancy to generate kinetic energy, and the shaft portion 22 of the rotor body 21 drives the generator to generate electricity or directly actuates the shaft work-driven device, meeting the development trend of green energy.

With reference to FIG. 5, note that the extension magnitude of the housing 31 of the float 3 relative to the rotor body 21 is increased by the isolating member 32. With reference to FIG. 10, during the float hidden stroke of the float 3, the housing 31 of the float 3 retracts to a position in which the outer surface 31a of the housing 31 is flush with the outer surface of the rotor body 21 to form a continuous arcuate surface, reducing the resistance while entering the liquid. With reference to FIG. 8, during the float completely exposed stroke of the float 3, the housing 31 of the float 3 fully extends beyond the outer surface of the rotor body 21, and the bottom end of the housing 31 of the float 3 is also located outside of the outer surface of the rotor body 21 such that the housing 31 is merely connected to the rotor body 21 by the isolating member 32. This increases the buoyancy of the float 3 and, thus, enhances the operational efficiency of the buoyancy-driven kinetic energy generating apparatus. Furthermore, in a case that the buoyancy-driven kinetic energy generating apparatus includes only one float 3 and it is difficult to reduce the friction between the components, to assure that the kinetic energy generated by the buoyancy-driven kinetic energy generating apparatus meets the expectation, one of the shafts 22a and 22b can be used as a power input shaft and is connected to a driving device to continuously input a small amount of kinetic energy for maintaining smooth operation of the buoyancy-driven kinetic energy generating apparatus. Alternatively, a plurality of the buoyancy-driven kinetic energy generating apparatuses can be connected in series, and the floats 3 of the buoyancy-driven kinetic energy generating apparatuses are located in different phase positions (i.e., the floats 3 of the buoyancy-driven kinetic energy generating apparatuses are alternately disposed). The buoyancy-driven kinetic energy generating apparatuses can operate simultaneously to continuously provide assistance in rotation, increasing the operational efficiency of each buoyancy-driven kinetic energy generating apparatus.

In other embodiments, the buoyancy-driven kinetic energy generating apparatus can include a plurality of floats 3 (odd-numbered or even-numbered floats 3) to continuously provide assistance in rotation of the rotor body 21, increasing the operational efficiency of the buoyancy-driven kinetic energy generating apparatus. Preferably, the floats are provided on the peripheral face 21b of the rotor body 21 at regular intervals to further increase the stability during rotation of the rotor body 21.

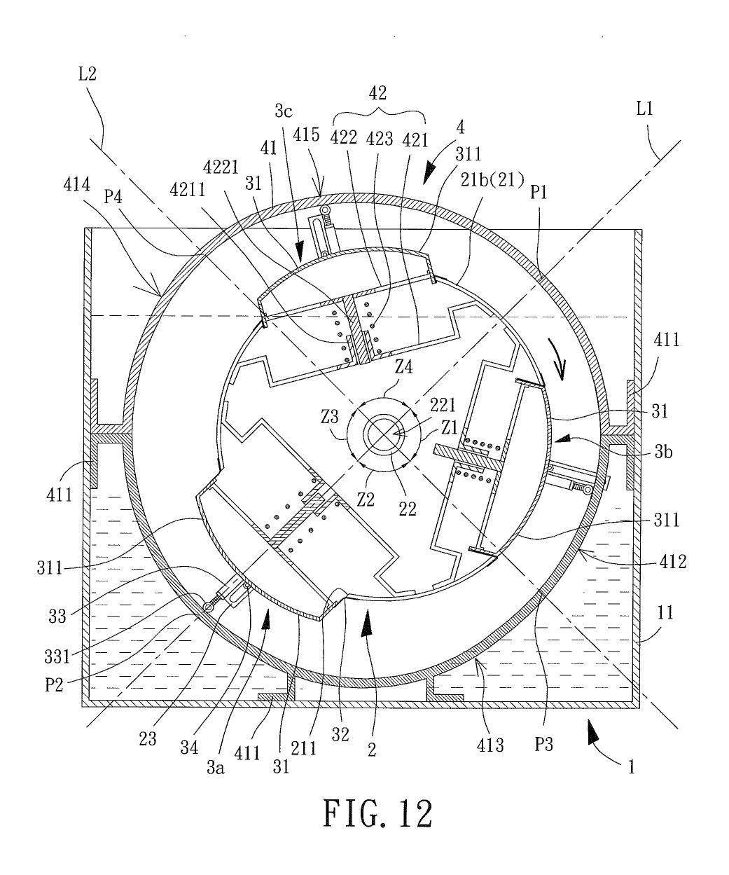

In a non-restricting embodiment shown in FIGS. 12-14, the buoyancy-driven kinetic energy generating apparatus includes three floats (a first float 3a and two second floats 3b and 3c). Each of the first float 3a and the second floats 3b and 3c completes a telescopic cycle relative to the peripheral face 21b of the rotor body 21 while the first and second floats 3a, 3b and 3c rotate a turn together with the rotor body 21. In the state shown in FIG. 12, the first float 3a is at the connection P2 between the first control movement section 413 and the second maintaining section 414. Namely, the first float 3a has finished the float gradual extending stroke and is about to undergo the float completely exposed stroke (the first float 3a is about to move from the float gradual extending section Z2 into the float completely exposed section Z3). In this state, the extension magnitude of the first float 3a is maximal to provide assistance in rotation of the rotor 2. At the same time, the second float 3b is in the float hidden section Z1 and undergoes the float hidden stroke, with the second float 3b maintaining the maximal retraction magnitude to avoid resistance to rotation of the rotor 2. The other second float 3c is located in the float gradual retracting section Z4 and undergoes the float gradual retracting stroke during which the second float 3c gradually retracts into the interior of the rotor body 21. By such an arrangement, the first float 3a can smoothly drive the rotor 2 to rotate.

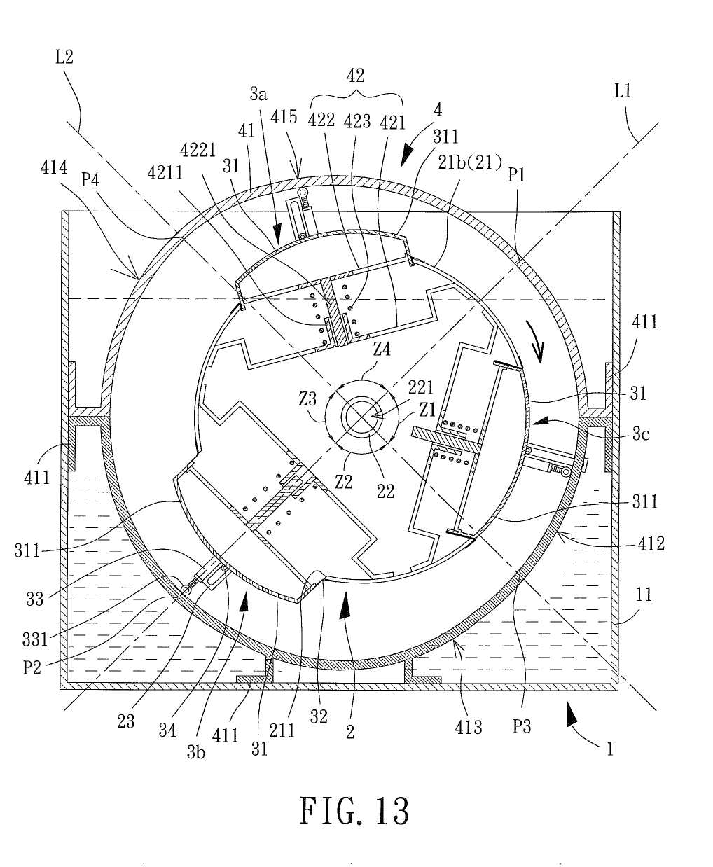

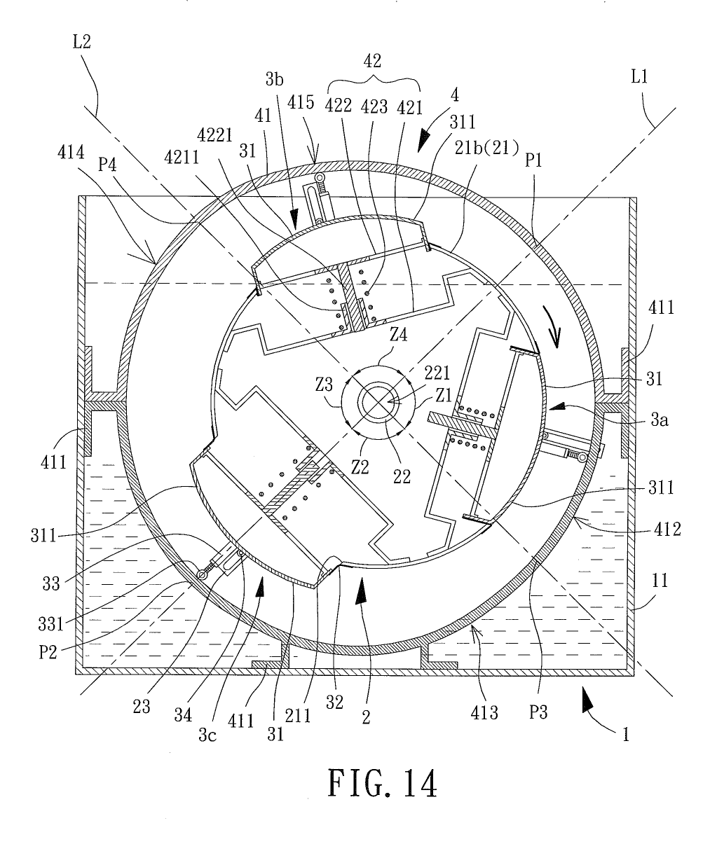

With reference to FIG. 13, next, the first float 3a leaves the float completely exposed section Z3 and enters the float gradual retracting section Z4. At the same time, the second float 3b enters the float gradual extending section Z2 and then the float completely exposed section Z3 to take over assistance in rotation of the rotor 2. With reference to FIG. 14, when the first float 3a leaves the float gradual retracting section Z4 and enters the float hidden section Z1, the second float 3c enters the float gradual extending section Z2 and then the float completely exposed section Z3 to take over assistance in rotation of the rotor 2. Thus, by sequential assistance in rotation of the rotor 2 from the first float 3a, the second float 3b, and the second float 3c, the rotor 2 can easily overcome the friction between the components and maintains smooth rotation, enhancing the operational efficiency of the buoyancy-driven kinetic energy generating apparatus.

With reference to FIGS. 5 and 12, note that the length of each float 3 (the first float 3a, the second float 3b, the second float 3c) can be reduced by provision of the isolating member 32. Furthermore, during the float completely exposed stroke of each float 3, the bottom of the housing 31 of the float 3 can extend beyond the outer surface of the rotor body 21, and the housing 31 is still connected to the rotor body 21 by the isolating member 32. Thus, the float 3 can generate buoyancy corresponding to the total area of the housing 31 and the isolating member 32 beyond the outer surface of the rotor body 21. On the other hand, during the float hidden stroke of each float 3, the housing 31 of the float 3 completely retracts into the rotor body 21 without occupying a large space. Thus, in the embodiment shown in FIGS. 12-14, the bottoms of the second support seats 422 of the balancing units 42 does not have to be close to the rotating center of the rotor body 21, avoiding interference between the balancing units 42 to increase assembling convenience.

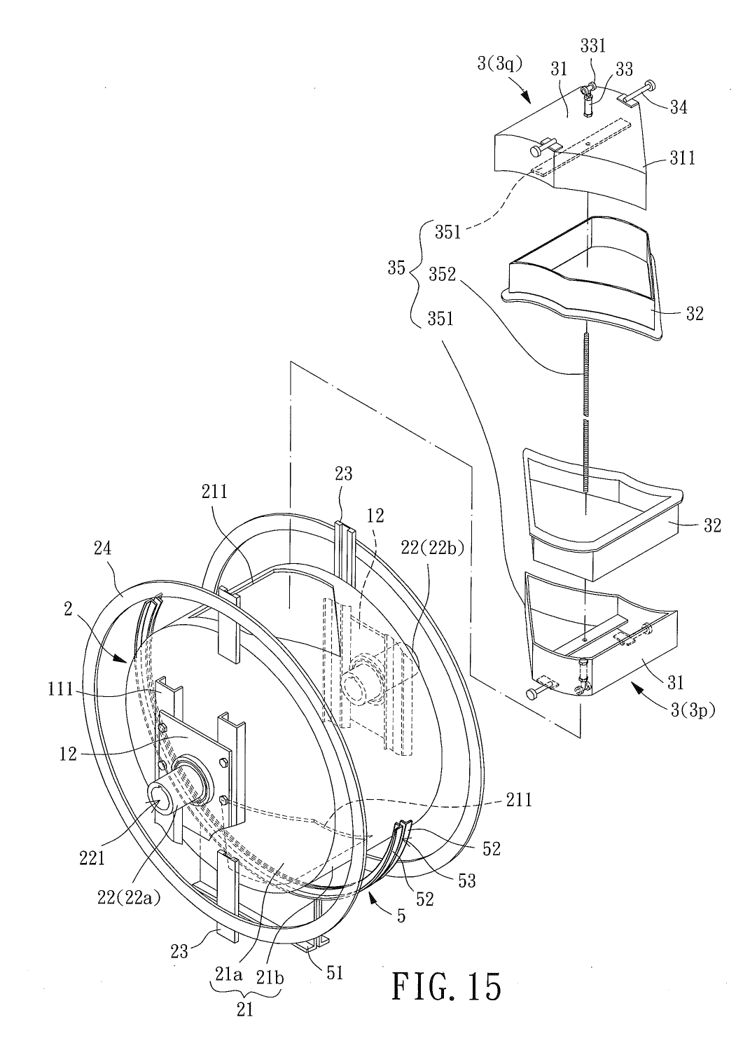

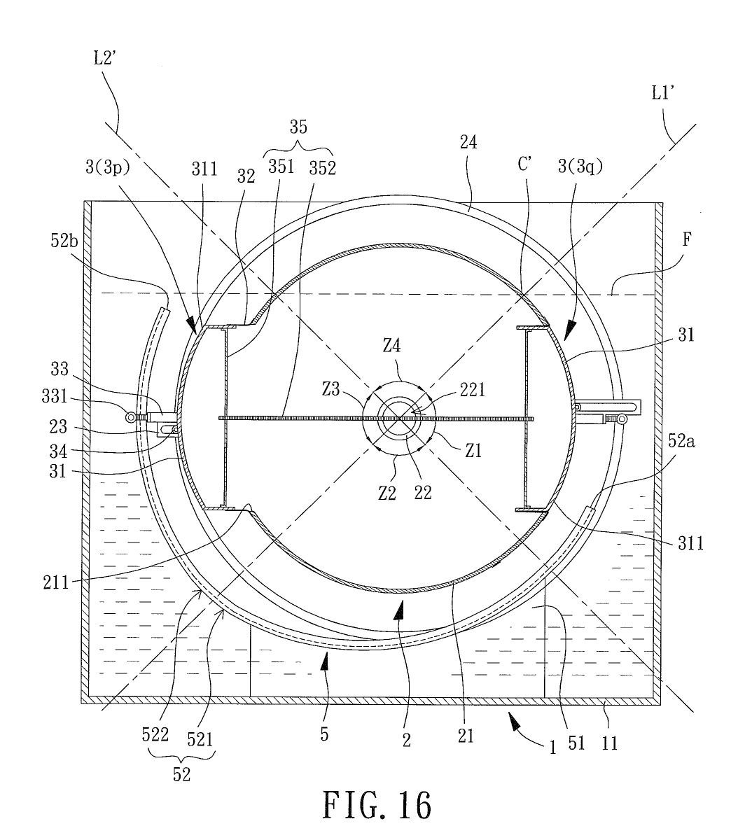

With reference to FIGS. 15 and 16, a buoyancy-driven kinetic energy generating apparatus of a second embodiment according to the present invention generally includes a base 1, a rotor 2, two floats 3, and a telescopic movement control module 5. The second embodiment is substantially the same as the first embodiment. The main differences between the first and second embodiments are that the number of floats 3 in the second embodiment is two, and the two floats 3 form a float unit. Furthermore, the floats 3 are opposite to each other in a diametric direction of the rotor body 21 and can move synchronously in a radial direction (i.e., the diametric direction) relative to the rotor body 21. The telescopic movement control module 5 is, thus, different from the telescopic movement control module 4 in the first embodiment (FIG. 2).

Specifically, the buoyancy-driven kinetic energy generating apparatus of this embodiment includes two floats 3. Thus, each end face 21a of the rotor body 21 includes a plurality of outer tracks 23 for respectively guiding the corresponding float 3. Furthermore, the outer tracks 23 on the same end face 21a are connected by a ring 24 to reinforce the structural strength of the outer tracks 23, reducing swaying or wobbling of the outer tracks 23 to enhance the stability of the telescopic movement of each float 3.

In the embodiment shown in FIGS. 15 and 16, the buoyancy-driven kinetic energy generating apparatus includes a float unit (i.e., two floats including a first float 3p and a second float 3q). The float unit includes a connecting module 35 connecting the housing 31 of the first float 3p to the housing 31 of the second float 3q. Thus, the first float 3p and the second float 3q can synchronously move in the radial direction relative to the rotor body 21. In this embodiment, the guiding member 33 of each of the first float 3p and the second float 3q is substantially T-shaped. The connecting module 35 includes two fixing member 351 and a connecting rod 352. The fixing members 351 are respectively mounted to the inner side of the first float 3p and the inner side of the second float 3q. Two ends of the connecting rod 352 are mounted to the fixing members 351. Preferably, the connecting rod 352 is connected to centers of the fixing members 351 to uniformly actuate the housings 31.

The guiding members 33 of the first float 3p and the second float 3q move in a movement plane (see FIG. 16) while the first and second floats 3p and 3q rotate jointly with the rotor body 21 about the rotating axis defined by the shaft portion 22 and passing through the rotating center of the rotor body 21. The movement plane extends through the rotating center of the rotor body 21 and extends perpendicularly to the rotating axis defined by the shaft portion 22 of the rotor body 21. Unless indicated otherwise, the definitions relating to spacings, radiuses, lines L1′ and L2′, connections P1, P2, P3, and P4, and sections Z1, Z2, Z3, and Z4 are made in reference to the movement plane. Namely, the lines L1′ and L2′, the connections P1, P2, P3, and P4, and the sections Z1, Z2, Z3, and Z4 are located in the movement plane, and the spacing or radius is also calculated based on the spacing between the rotating center of the rotor body 21 and the curvature in the movement plane.

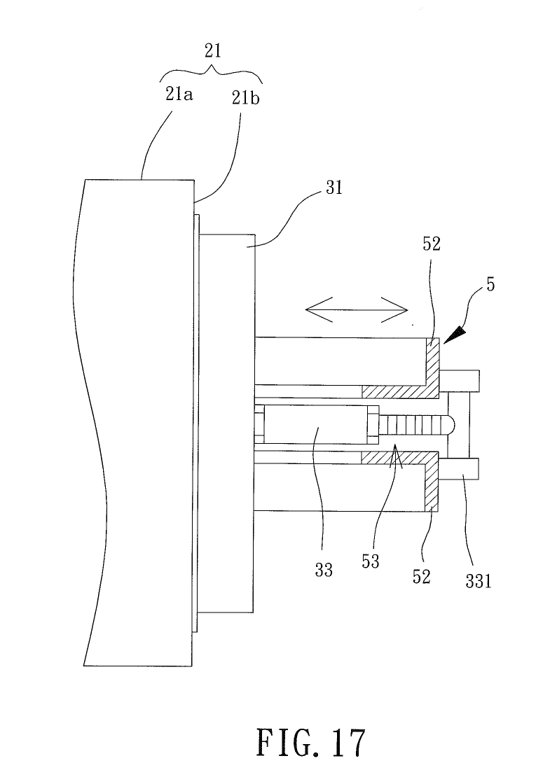

With reference to FIGS. 16 and 17, the telescopic movement control module 5 faces a portion of the peripheral face 21b of the rotor body 21. As a non-restrictive example, the telescopic movement control module 5 in this embodiment is substantially aligned with a lower portion of the rotor body 21. The telescopic movement control module 5 includes a bracket 51 and two rails 52. The bracket 51 is mounted to the inner wall of the tank 11. Each rail 52 is substantially arcuate. The rails 52 are mounted to the bracket 51 and are parallel to and spaced from each other to form a passage 53 therebetween. By such an arrangement, when the rotor body 21 rotates to make the guiding member 33 of the first float 3p or the second float 3q contact the rails 52, the substantially T-shaped guiding member 33 extends through the passage 53, and the roller 331 of the guiding member 33 abutting outer surfaces of the rails 52. The rails 52 control the movement of the guiding member 33 to control the first float 3p or the second float 3q to telescope relative to the peripheral face 21b of the rotor body 21 and to make the first float 3p and the second float 3q synchronously move relative to the rotor body 21 in the radial direction.

With reference to FIGS. 7 and 16, when the buoyancy-driven kinetic energy generating apparatus operates, each of the first float 3p and the second float 3q rotates jointly with the rotor body 21a turn while completing a telescopic cycle relative to the peripheral face 21b of the rotor body 21. Each telescopic cycle includes a float hidden stroke, a float gradual extending stroke, a float completely exposed stroke, and a float gradual retracting stroke. In this embodiment, the float hidden stroke, the float gradual extending stroke, the float completely exposed stroke, and the float gradual retracting stroke each of the first float 3p and the second float 3q are preferably spaced from each other in a circumferential direction at regular intervals. The float hidden stroke of the first float 3p corresponds to the float completely exposed stroke of the second float 3q. The float gradual extending stroke of the first float 3p corresponds to the float gradual retracting stroke of the second float 3q. The float completely exposed stroke of the first float 3p corresponds to the float hidden stroke of the second float 3q. The float gradual retracting stroke of the first float 3p corresponds to the float gradual extending stroke of the second float 3q.

Furthermore, each rail 52 includes a start end 52a and a terminal end 52b. The extending direction from the start end 52a to the terminal end 52b of each rail 52 is substantially the rotating direction of the rotor 2. Thus, the first float 3p and the second float 3q can enter the rails 52 via the start ends 52a of the rails 52 and can leave the rails 52 via the terminal ends 52b of the rails 52. Each rail 52 includes a movement control section 521 and a maintaining section 522 following the movement control section 521 in the rotating direction of the rotor 2. The spacing between the outer surface of the movement control section 521 to the rotating center of the rotor body 21 increases from a point of the movement control section 521 toward a connection between the movement control section 521 and the maintaining section 522. The outer surface of the maintaining section 522 and the peripheral face 21b of the rotor body 21 are concentric.

A telescopic movement end line L1′ passes through the connection between the movement control section 521 and the maintaining section 522 and the rotating center of the rotor body 21 and is preferably at an angle of 45° to a horizontal line. A telescopic movement start line L2′ passes through the rotating center of the rotor body 21 and is orthogonal to the telescopic movement end line L1′. The telescopic movement end line L1′ and the telescopic movement start line L2′ divide the movement plane into four sections (starting from the telescopic movement end line L1′ in the rotating direction of the rotor 2): a float hidden section Z1, a float gradual extending section Z2, a float completely exposed section Z3, and a float gradual retracting section Z4. The space in the tank 11 is also divided into four sectors (corresponding to the four sections Z1-Z4) by a first plane and a second plane. The first plane includes the telescopic movement end line L1′ and extends perpendicularly to the movement plane. The second plane includes the telescopic movement start line L2′, extends perpendicularly to the movement plane, and is orthogonal to the first plane.

The float hidden section Z1 is opposite to the float completely exposed section Z3 in a diametric direction of the rotor body 21. The float gradual extending section Z2 is opposite to the float gradual retracting section Z4 in a diametric direction of the rotor body 21. Each of the first float 3p and the second float 3q can undergo the float hidden stroke, the float gradual extending stroke, the float completely exposed stroke, and the float gradual retracting stroke.

Furthermore, the liquid contained in the tank 11 preferably has a level F at the upper portion of the rotor body 21 where the telescopic movement end line L1′ passes the rotor body 21 (see point C′ in FIG. 16), such that the float gradual extending section Z2 is located below the level F and such that the float gradual retracting section Z4 is located above the level F. This assures that when the first float 3p or the second float 3q enters the float gradual retracting section Z4, the first float 3p or the second float 3q can smoothly retract into the interior of the rotor body 21 in the air without resistance caused by the liquid and can enter the liquid at a state having the maximal retraction magnitude. The resistance to the rotation of the rotor body 21 at the moment the first float 3p or the second float 3q entering the liquid and affected by the liquid resistance can be reduced, enhancing the overall kinetic energy generating efficiency of the buoyancy-driven kinetic energy generating apparatus.

With reference to FIG. 16, in the buoyancy-driven kinetic energy generating apparatus of the second embodiment according to the present invention, when the tank 11 has not been filled with a sufficient amount of liquid, the first float 3p is located in the float completely exposed section Z3, and the roller 331 keeps contacting the maintaining sections 522 of the rails 52 such that the extension magnitude of the first float 3p is maximal. At the same time, the second float 3q is in the float hidden section Z1 and has the maximal retraction magnitude.

When the tank 11 is filled with a sufficient amount of liquid, the rotor body 21 can create a relatively great pre-buoyancy in the liquid. Furthermore, due to the space in the housing 31 of the first float 3p, the first float 3p in the float completely exposed section Z3 additionally and locally increases the buoyancy of the rotor body 21 to imbalance the rotor body 21 such that the rotor body 21 starts to rotate. Thus, the guiding member 33 of the first float 3p keeps contacting the outer surfaces of the maintaining sections 522 of the rails 52 until the guiding member 33 disengages from the terminal ends 52b of the rails 52.

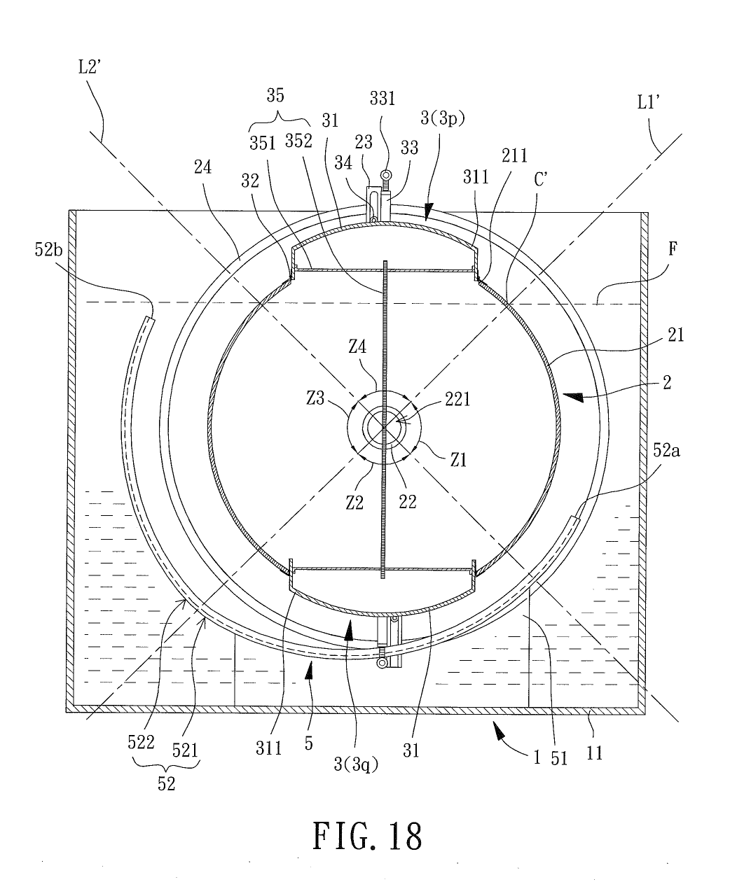

With reference to FIG. 18, after the first float 3p disengages from the maintaining sections 522 of the rails 52, the roller 331 of the guiding member 33 of the second float 3q contacts the outer surfaces of the movement control sections 521 of the rails 52 (i.e., the second float 3q is aligned with the telescopic movement start line L2′. The rails 52 start to pull the second float 3q into the float gradually extending stroke, and the second float 3q gradually extends out of the interior of the rotor body 21. Thus, the float unit moves in the diametrical direction relative to the rotor body 21, and the first float 3p is synchronously moved into the float gradual retracting stroke and gradually retracts into the interior of the rotor body 21.

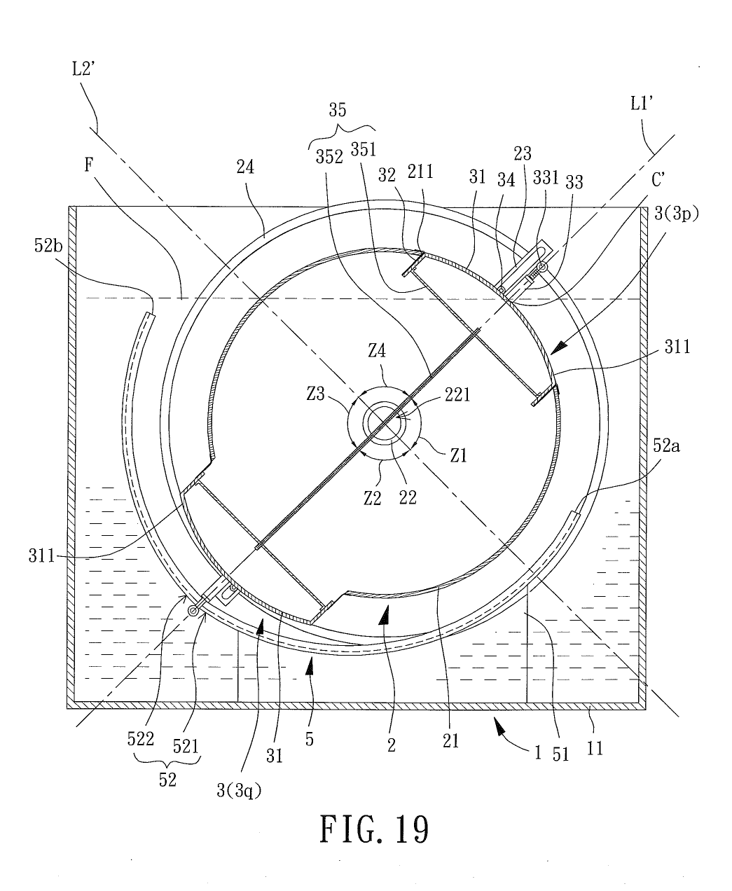

With reference to FIG. 19, when the second float 3q is aligned with the maintaining sections 522 of the rails 52 (i.e., the second float 3q is aligned with the telescopic movement end line L1′), the second float 3q is pulled and has the maximal extension magnitude. Thus, the rotor body 21 is driven to rotate under the maximal buoyancy. At the same time, the first float 3p above the level F is actuated to a state having the maximal retraction magnitude, such that the first float 3p can reenter the liquid and the float hidden section Z1 with the minimal resistance.

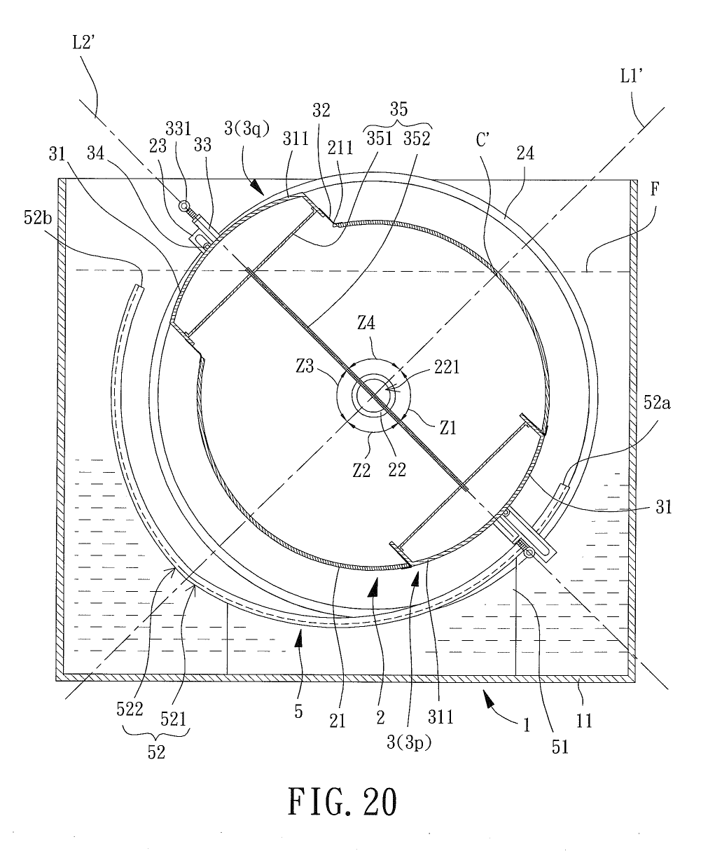

While the second float 3q is aligned with the maintaining sections 522 of the rails 52, the rails 52 stop pulling the second float 3q, and the maintaining sections 522 of the rails 52 keep the second float 3q in the state having the maximal extension magnitude until the second float 3q disengages from the terminal ends 52b of the rails 52 (see FIG. 20). On the other hand, the first float 3p reentering the liquid will rotate jointly with the rotor body 21 to a position aligned with the rails 52, and the guiding member 33 of the first float 3p contact the outer surfaces of the movement control sections 521 of the rails 52 such that the first float 3p gradually extends out of the interior of the rotor body 21 to its maximal extension magnitude (see FIG. 16), completing a telescopic cycle.

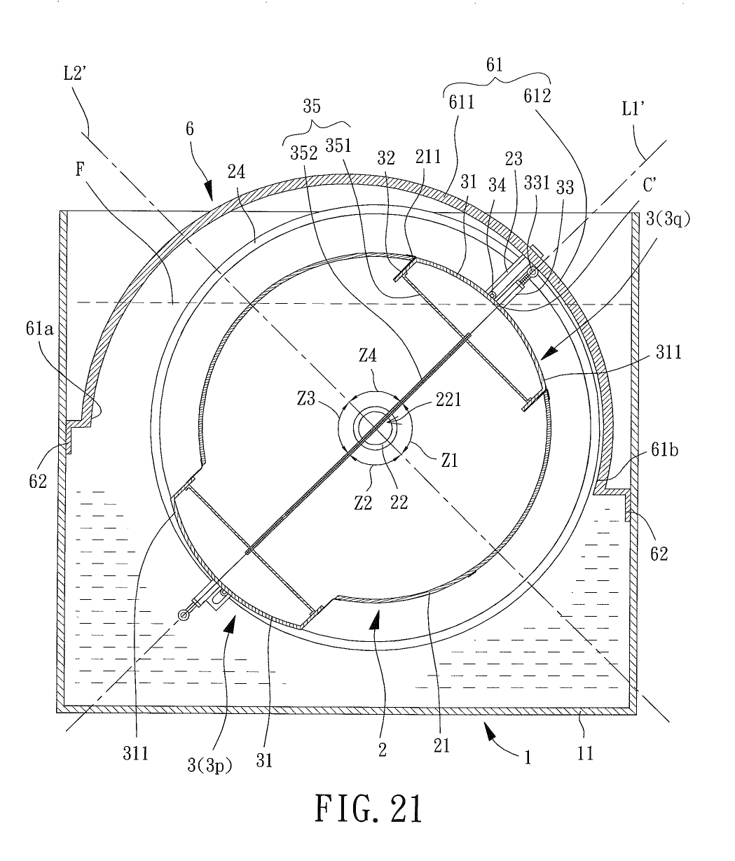

FIG. 21 shows a buoyancy-driven kinetic energy generating apparatus of a third embodiment according to the present invention. The third embodiment is substantially the same as the second embodiment except that the telescopic movement control device 6 is different in shape and location. Namely, in contrast to the second embodiment in which the float unit is actuated by pulling, the float unit in this embodiment is actuated by pressing.

Specifically, the telescopic movement control device 6 of this embodiment is mounted in the tank 11. As a non-restrictive example, the telescopic movement control device 6 is in the upper portion of the rotor body 21. The telescopic movement control device 6 includes a pressing board 61 and a plurality of fasteners 62. The pressing board 61 is a substantially arcuate board and includes a start end 61a and a terminal end 61b. The extending direction of the pressing board 61 from the start end 61a to the terminal end 61b is the rotating direction of the rotor 2, such that each of the first float 3p and the second float 3q enters the range of the pressing board 61 via the start end 61a and leaves the range of the pressing board 61 via the terminal end 61b. The pressing board 61 includes a movement control section 611 and a maintaining section 612 following the movement control section 611 in the rotating direction of the rotor 2. A spacing between the movement control section 611 and the rotating center of the rotor 2 decreases from a point of the movement control section 611 toward the maintaining section 612. The inner surface of the maintaining section 612 is concentric to the peripheral face 21b of the rotor body 21.

The guiding members 33 of the first float 3p and the second float 3q move in a movement plane while the first and second floats 3p and 3q rotate jointly with the rotor body 21 about the rotating axis defined by the shaft portion 22 and passing through the rotating center of the rotor body 21. The movement plane extends through the rotating center of the rotor body 21 and extends perpendicularly to the rotating axis of the rotor body 21. Unless indicated otherwise, the definitions relating to spacings, radiuses, lines L1′ and L2′, connections P1, P2, P3, and P4, and sections Z1, Z2, Z3, and Z4 are made in reference to the movement plane. Namely, the lines L1′ and L2′, the connections P1, P2, P3, and P4, and the sections Z1, Z2, Z3, and Z4 are located in the movement plane, and the spacing or radius is also calculated based on the spacing between the rotating center of the rotor body 21 and the curvature in the movement plane.

A telescopic movement end line L1′ passes through the connection between the movement control section 611 and the maintaining section 612 and the rotating center of the rotor body 21 and is preferably at an angle of 45° to a horizontal line. A telescopic movement start line L2′ passes through the rotating center of the rotor body 21 and is orthogonal to the telescopic movement end line L1′. The telescopic movement end line L1′ and the telescopic movement start line L2′ divide the movement plane into four sections (starting from the telescopic movement end line L1′ in the rotating direction of the rotor 2): a float hidden section Z1, a float gradual extending section Z2, a float completely exposed section Z3, and a float gradual retracting section Z4. The space in the tank 11 is also divided into four sectors (corresponding to the four sections Z1-Z4) by a first plane and a second plane. The first plane includes the telescopic movement end line L1′ and extends perpendicularly to the movement plane. The second plane includes the telescopic movement start line L2′, extends perpendicularly to the movement plane, and is orthogonal to the first plane.

The float hidden section Z1 is opposite to the float completely exposed section Z3 in a diametric direction of the rotor body 21. The float gradual extending section Z2 is opposite to the float gradual retracting section Z4 in a diametric direction of the rotor body 21. Each of the first float 3p and the second float 3q can undergo the float hidden stroke, the float gradual extending stroke, the float completely exposed stroke, and the float gradual retracting stroke.

By such an arrangement, in operation of the buoyancy-driven kinetic energy generating apparatus of the third embodiment according to the present invention, the first float 3p and the second float 3q can separately undergo the float hidden stroke, the float gradual extending stroke, the float completely exposed stroke, and the float gradual retracting stroke in the float hidden section Z1, the float gradual extending section Z2, the float completely exposed section Z3, and the float gradual retracting section Z4 (c.f. FIG. 7), providing alternate assistance in rotation of the rotor body 21 to maintain smooth rotation of the rotor body 21.

When the roller 331 of the guiding member 33 of the first float 3p (or the second float 3q) contacts the inner surface of the movement control section 611 of the pressing board 61 (i.e., the roller 331 is aligned with the telescopic movement start line L2′), the pressing board 61 starts to push the first float 3p (or the second float 3q) into the float gradually retracting stroke, and the second float 3q (or the first float 3p) gradually extends out of the interior of the rotor body 21 under actuation by the connecting module 35. Thus, the float unit telescopes in the radial direction relative to the rotor body 21. The gradually increased buoyancy of the second float 3q and the first float 3p alternately assist in rotation of the rotor body 21.

When the roller 331 of the guiding member 33 of the first float 3p (or the second float 3q) contacts the inner surface of the maintaining section 612 of the pressing board 61 (i.e., the roller 311 is aligned with the telescopic movement end line L1′), the first float 3p (or the second float 3q) is pressed to the maximal retraction magnitude, and the pressing board 61 stops pressing the first float 3p (or the second float 3q) such that the first float 3p (or the second float 3q) undergoes the float hidden stroke. At the same time, the second float 3q (or the first float 3p) is actuated by the connecting module 35 to the maximal extension magnitude and undergoes the float completely exposed stroke. Thus, the buoyancy-driven kinetic energy generating apparatus of the third embodiment according to the present invention can achieve the same effect of enhancing the kinetic energy generating effect as the first and second embodiments.

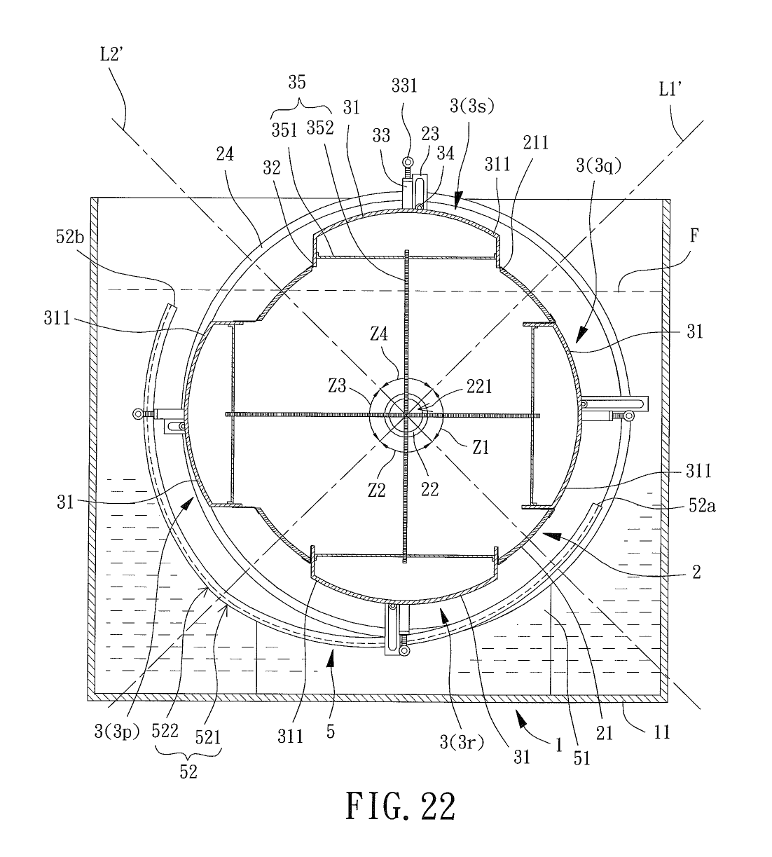

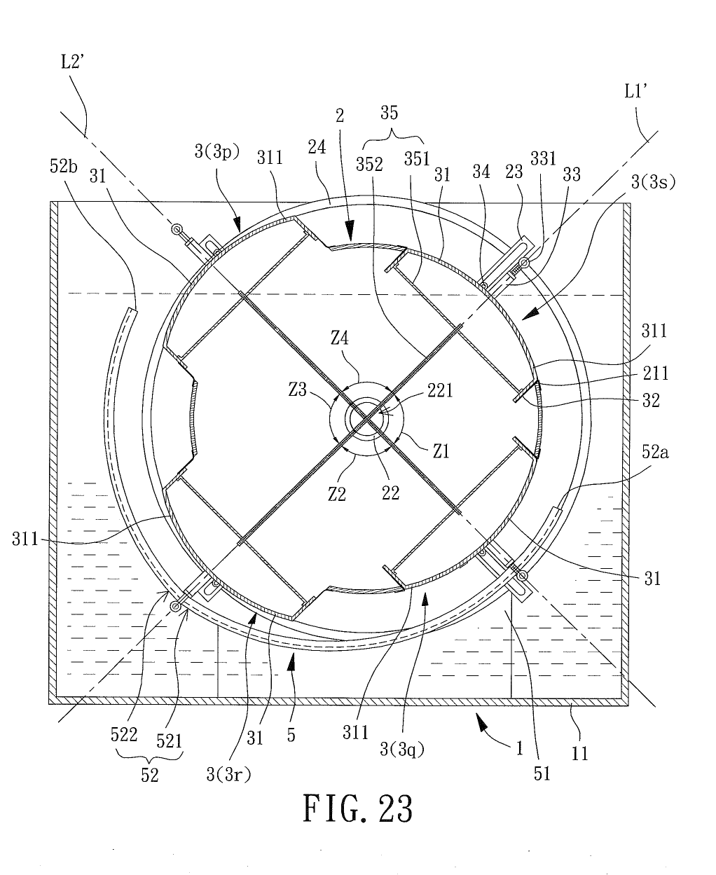

FIGS. 22 and 23 show a buoyancy-driven kinetic energy generating apparatus of a fourth embodiment according to the present invention. The fourth embodiment is substantially the same as the second embodiment except for the number of the float units to further enhance the kinetic energy generating effect.

Specifically, the buoyancy-driven kinetic energy generating apparatus includes two float units in the embodiment shown in FIGS. 22 and 23. Namely, there are four floats 3 including a first float 3p, a second float 3q, a third float 3r, and a fourth float 3s. The first float 3p and the second float 3q form a float unit. The third float 3r and the fourth float 3s form another float unit. The housing 31 of the first float 3p and the housing 31 of the second float 3q are opposite to each other in a diametric direction of the rotor body 21 and are connected by a connecting module 35, such that the first float 3p and the second float 3q synchronously move relative to the rotor body 21 in the corresponding radial direction. Likewise, the housing 31 of the third float 3r and the housing 31 of the fourth float 3s are opposite to each other in a diametric direction of the rotor body 21 and are connected by another connecting module 35, such that the third float 3r and the fourth float 3s synchronously move relative to the rotor body 21 in the corresponding radial direction. Furthermore, the first float 3p, the second float 3q, the third float 3r, and the fourth float 3s are preferably mounted to the peripheral face 21b of the rotor body 21 and are spaced from each other at regular intervals to further enhance the rotational stability of the rotor body 21.

When the buoyancy-driven kinetic energy generating apparatus of the fourth embodiment according to the present invention operates, if the first float 3p is in a position shown in FIG. 22, the first float 3p is in the float completely exposed section Z3, and the roller 331 of the guiding member 33 of the first float 3p keeps contacting the outer surfaces of the maintaining sections 522 of the rails 52 such that the first float 3p has the maximal extension magnitude to provide the maximal buoyancy to drive the rotor body 21 to rotate. The second float 3q corresponding to the first float 3p is located in the float hidden section Z1 and maintains the state having the maximal retraction magnitude. Thus, the float unit formed by the first float 3p and the second float 3q will not move temporarily in the corresponding radial direction relative to the rotor body 21. At the same time, the third float 3r is in the float gradual extending section Z2, and the fourth float 3s is in the float gradual retracting section Z4. The roller 331 of the guiding member 33 of the third float 3r contacts the outer surfaces of the movement control sections 521 of the rails 52. The rails 52 provide the third float 3r with a pulling force to gradually increase the extension magnitude of the third float 3r out of the rotor body 21, gradually increasing the buoyancy to assist in rotation of the rotor body 21. Furthermore, the float unit formed by the third float 3r and the fourth float 3s move relative to the rotor body 21 in the corresponding radial direction such that the fourth float 3s is actuated to gradually retract into the interior of the rotor body 21 in the float hidden section Z1.

With reference to FIG. 23, after the roller 331 of the guiding member 33 of the first float 3p disengages from the terminal ends 52b of the rails 52, roller 331 of the guiding member 33 of the corresponding second float 3q immediately contacts the outer surfaces of the movement control sections 521 of the rails 52 (i.e., the second float 3q is aligned with the telescopic movement start line L2′). Thus, the second float 3q is pulled by the rails 52 and undergoes the float gradually extending stroke and gradually extends out of the rotor body 21 to gradually increase the buoyancy assisting in rotation of the rotor body 21. Furthermore, the float unit formed by the first float 3p and the second float 3q is about to move relative to the rotor body 21 in the corresponding radial direction for synchronously moving the first float 3p into the float gradually retracting stroke and gradually retracting the first float 3p into the interior of the rotor body 21. On the other hand, while the second float 3q passes through the telescopic movement start line L2′, the third float 3r passes through the telescopic movement end line L1′ to undergo the float completely exposed stroke such that the third float 3r maintains the maximal extension magnitude in the float completely exposed section Z3 to drive the rotor body 21 to rotate with the maximal buoyancy. The corresponding fourth float 3s undergoes the float hidden stroke and maintains the maximal retraction magnitude in the float hidden section Z1. Thus, the float unit formed by the third float 3r and the fourth float 3s do not move temporarily in the corresponding radial direction relative to the rotor body 21.

By such an arrangement, in operation of the buoyancy-driven kinetic energy generating apparatus of the fourth embodiment according to the present invention, the first float 3p, the second float 3q, the third float 3r, and the fourth float 3s can separately undergo the float hidden stroke, the float gradual extending stroke, the float completely exposed stroke, and the float gradual retracting stroke in the float hidden section Z1, the float gradual extending section Z2, the float completely exposed section Z3, and the float gradual retracting section Z4 (c.f. FIG. 7), providing alternate assistance in rotation of the rotor body 21 to maintain smooth rotation of the rotor body 21. Compared to the first, second, and third embodiments, the fourth embodiment further enhances the kinetic energy generating efficiency.

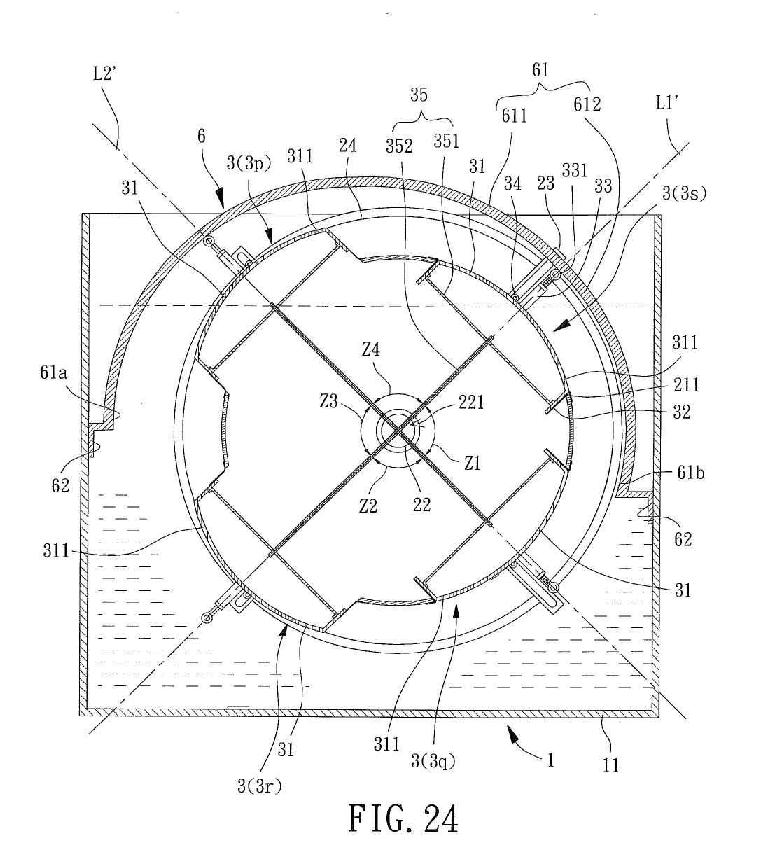

FIG. 24 shows a buoyancy-driven kinetic energy generating apparatus of a fifth embodiment according to the present invention substantially the same as the fourth embodiment. The main difference between the fifth embodiment and the fourth embodiment is that the telescopic movement control module 6 of the third embodiment is used in the fifth embodiment to actuate the floats by pressing. Thus, the buoyancy-driven kinetic energy generating apparatus of the fifth embodiment according to the present invention can also achieve the same effect of the fourth embodiment in enhancing the kinetic energy generating efficiency. The operational principles of the buoyancy-driven kinetic energy generating apparatus of the fifth embodiment are substantially the same as those mentioned above and are not set forth again to avoid redundancy.

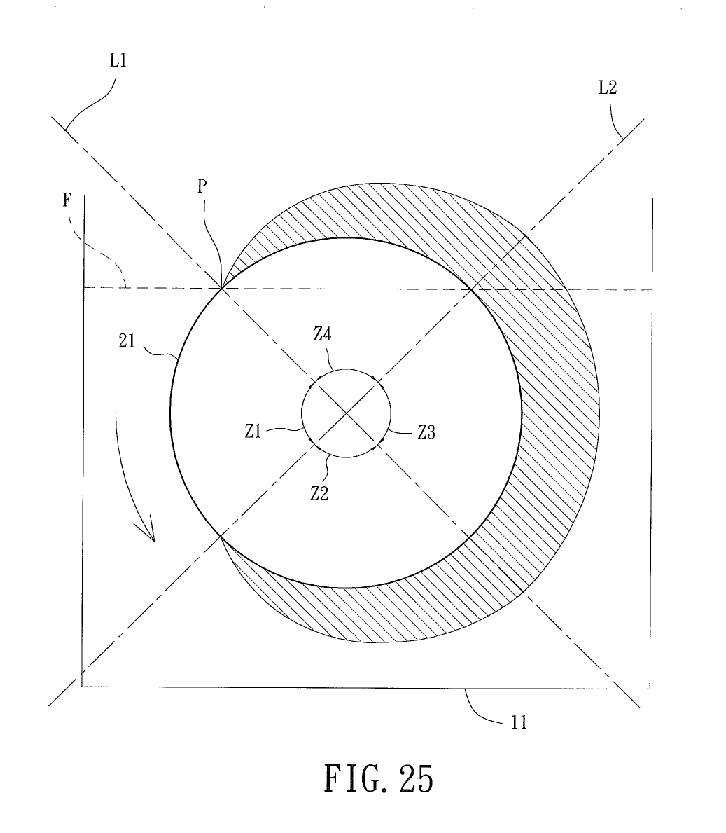

FIG. 25 is a schematic diagram illustrating the extension magnitude of the float 3 when the rotor 2 according to the present invention rotates in a counterclockwise direction. The hatching area in FIG. 25 indicates the extension magnitude of the float 3 in the tank 11. Namely, the rotor body 21 can rotate in the tank 11 in the counterclockwise direction. When the buoyancy-driven kinetic energy generating apparatus operates, the float 3 completes a telescopic cycle relative to the peripheral face 21b of the rotor body 21 while the float 3 rotates a round together with the rotor body 21. Each telescopic cycle includes four strokes: a float hidden stroke, a float gradual extending stroke, a float completely exposed stroke, and a float gradual retracting stroke. The float 3 maintains its maximal retraction magnitude (i.e., the extension magnitude is minimal) during the float hidden stroke. The extension magnitude of the float 3 increases gradually during the float gradual extending stroke. The float 3 maintains its maximal extension magnitude during the float completely exposed stroke. The extension magnitude of the float 3 decreases gradually during the float gradual retracting stroke, and the float 3 has the maximal retraction magnitude when the float 3 returns to the float hidden stroke.

The number of the floats 3 ranges from 1 to 4 in the embodiments shown. However, the number of the floats 3 can be larger than four and can be adjusted and modified according to needs, which can be appreciated by one having ordinary skill in the art. The present invention is not restricted by the embodiments shown. Furthermore, when the number of the floats 3 is more than one, the floats 3 do not have to be spaced from each other at regular intervals. The spacing between two adjacent floats 3 can be adjusted to control the speed change of the rotor 2. Furthermore, the floats 3 of the buoyancy-driven kinetic energy generating apparatus according to the present invention can telescope on the opposite end faces 21a of the rotor body 21. In another example, the float 3 in the extended state can be flush with the outer surface of the rotor body 21 (the end faces 21a or the peripheral face 21b), and the float 3 in the retracted state is in a recess in the outer surface of the rotor body 21, which also can imbalance the rotor body 21 and cause rotation of the rotor body 21.

In the embodiments shown, the float hidden section Z1, the float gradual extending section Z2, the float completely exposed section Z3, and the float gradual retracting section Z4 extend through the same angle in the movement plane. Namely, each of the float hidden stroke, the float gradual extending stroke, the float completely exposed stroke, and the float gradual retracting stroke is 90°. However, the angle of each of the float hidden stroke, the float gradual extending stroke, the float completely exposed stroke, and the float gradual retracting stroke can be changed according to needs.

In view of the foregoing, in the buoyancy-driven kinetic energy generating apparatus according to the present invention, a rotor body 21 containing a mass is received in a tank 11 containing a liquid having a density larger than that of the mass, such that a great pre-buoyancy is exerted to the rotor body 21 due to the density difference and the gravitational force, greatly increasing the total buoyancy. Furthermore, local buoyancy on the rotor body 21 is changed by controlling the float 3 to telescope relative to the rotor body 21, causing imbalance of the rotor body 21 and, hence, causing rotation of the rotor body 21. Thus, the input kinetic energy required to maintain rotation of the rotor body 21 can effectively be reduced, effectively reducing the costs for generating kinetic energy. Furthermore, by cooperation of the inertia generated by the rotor body 21 of a large volume and the arcuate telescopic path of the float 3 rotating jointly with the rotor body 21, the rotational resistance of the rotor body 21 is reduced, such that the buoyancy-driven kinetic energy generating apparatus can operate smoothly to stably and continuously generate kinetic energy, enhancing the kinetic energy generating efficiency.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A buoyancy-driven kinetic energy generating apparatus comprising:
a base including a tank;
a rotor including a rotor body and a shaft portion, with the shaft portion coupled to the rotor body and the tank, with the rotor body rotatably received in the tank about a rotating axis defined by the shaft portion;
at least one float mounted to the rotor body, with the at least one float telescoping relative to the rotor body while the rotor body rotates about the rotating axis; and
a telescopic movement control module mounted in the tank, with the telescopic movement control module controlling the at least one float to telescope relative to the rotor body while the rotor body rotates.

2. The buoyancy-driven kinetic energy generating apparatus as claimed in claim 1, with the tank adapted to receive a liquid, with the rotor body having an interior, and with the interior of the rotor body being hollow and adapted to receive a mass having a density smaller than a density of the liquid to create buoyancy to float the rotor body on the liquid in the tank.

3. The buoyancy-driven kinetic energy generating apparatus as claimed in claim 1, with the tank adapted to receive a liquid, with the rotor body having a density smaller than a density of the liquid to create buoyancy to float the rotor body on the liquid in the tank.

4. The buoyancy-driven kinetic energy generating apparatus as claimed in claim 1, with the base including two shaft fixing portions, with the shaft portion of the rotor body including two shafts, with the two shafts respectively mounted to the two shaft fixing portions and coaxial to each other, and with each of the two shafts including a shaft hole intercommunicating the interior of the rotor body with an outside of the tank.

5. The buoyancy-driven kinetic energy generating apparatus as claimed in claim 1, with the at least one float including a first float, with the first float moving relative to the rotor body while the first float rotates jointly with the rotor body about the rotating axis, with the rotor body including an outer surface, with the first float mounted to the outer surface of the rotor body, and with the first float telescoping relative to the outer surface of the rotor body while the first float and the rotor body rotate jointly about the rotating axis.

6. The buoyancy-driven kinetic energy generating apparatus as claimed in claim 5, with the first float having an outer surface, with the outer surface of the first float flush with the outer surface of the rotor body when the first float has a maximal retraction magnitude relative to the outer surface of the rotor body.

7. The buoyancy-driven kinetic energy generating apparatus as claimed in claim 5, with the outer surface of the rotor body including a peripheral face having a first slot, with the first float including a housing slideably received in the first slot, with the housing of the first float having an opening facing an interior of the rotor body, with the first float further including an isolating member connecting the housing of the first float to the rotor body, and with the isolating member of the first float sealing the first slot.

8. The buoyancy-driven kinetic energy generating apparatus as claimed in claim 7, with the telescopic movement control module including a control guiding member and a first balancing unit, with the control guiding member fixed to the tank, and with the first balancing unit mounted between the rotor body and the first rotor and keeping the first float contacting the control guiding member.

9. The buoyancy-driven kinetic energy generating apparatus as claimed in claim 8, with the first balancing member including a first support seat fixed to an inner wall of the rotor body, a second support seat fixed to an inner wall of the housing, and an elastic returning member having two ends respectively pressing against the first support seat and the second support seat.

10. The buoyancy-driven kinetic energy generating apparatus as claimed in claim 8, with the peripheral face being orthogonal to a movement plane perpendicular to the rotating axis, with the control guiding member being annular and mounted around the rotor body, with the control guiding member including a first maintaining section, a first movement control section, a second maintaining section and a second movement control section in sequence, with each of the first maintaining section and the second maintaining section connected between the first movement control section and the second movement control section, with each of the first movement control section and the second movement control section connected between the first maintaining section and the second maintaining section, with the control guiding member including a continuous annular inner surface, with an inner surface of the first maintaining section and an inner surface of the second maintaining section being concentric to the peripheral face of the rotor body, with a radius of curvature of the first maintaining section in the movement plane being smaller than a radius of curvature of the second maintaining section in the movement plane, with a spacing between an inner surface of the first movement control section and the rotating center of the rotor body in the movement plane increasing from a connection end of the first movement control section connected to the first maintaining section towards another connection end of the first movement control section connected to the second maintaining section, and with a spacing between an inner surface of the second movement control section and the rotating center of the rotor body in the movement plane decreasing from a connection end of the second movement control section connected to the second maintaining section towards another connection end of the second movement control section connected to the first maintaining section.

11. The buoyancy-driven kinetic energy generating apparatus as claimed in claim 10, with the first float further including a guiding member mounted on the outer surface of the housing, with the guiding member having a roller, with the roller contacting the continuous annular inner surface of the control guiding member to control telescopic movement of the first float, with the isolating member of the first float made of an elastic leakproof material, with the first float having a minimal extension magnitude and with the outer surface of the first float flush with the peripheral face of the rotor body while the roller of the first float moves in the first maintaining section, with the first float having a maximal extension magnitude while the roller of the first float moves in the second maintaining section, with an extension magnitude of the first float increasing gradually while the roller of the first float moves in the first movement control section, with the extension magnitude of the first float decreasing gradually while the roller of the first float moves in the second movement control section, and with the housing of the first float located outside of the rotor body while the roller of the first float moves in the second maintaining section.

12. The buoyancy-driven kinetic energy generating apparatus as claimed in claim 11, with the at least one float further including a plurality of second floats, with the peripheral face of the rotor body further including a plurality of second slots, with each of the plurality of second floats including a housing slideably received in one of the plurality of second slots, with the housing of each of the plurality of second floats having an opening facing the interior of the rotor body, with the housing of each of the plurality of second floats further including a roller mounted to an outer surface of the housing, with each of the plurality of second floats further including an isolating member connecting the housing of the second float to the rotor body, with the isolating member of each of the plurality of second floats sealing one of the plurality of second slots, with the telescopic movement control module further including a plurality of second balancing units, with each of the second balancing units mounted between the rotor body and one of the plurality of second floats to keep the rotor of the second float contacting the control guiding member, with each of the plurality of second floats having a minimal extension magnitude and with the outer surface of the housing of the second float flush with the peripheral face of the rotor body while the roller of the second float moves in the first maintaining section, with each of the plurality of second floats having a maximal extension magnitude while the roller of the second float moves in the second maintaining section, with the extension magnitude of each of the plurality of second floats increasing gradually while the roller of the second float moves in the first movement control section, with the extension magnitude of each of the plurality of second floats decreasing gradually while the roller of the second float moves in the second movement control section, and with the housing of each of the plurality of second floats located outside of the rotor body while the roller of the second float moves in the second maintaining section.

13. The buoyancy-driven kinetic energy generating apparatus as claimed in claim 12, with the first float and the plurality of second floats spaced from each other at regular intervals,

14. The buoyancy-driven kinetic energy generating apparatus as claimed in claim 7, with the peripheral face being orthogonal to a movement plane perpendicular to the rotating axis, with the at least one float further including a second float, with the first and second floats opposite to each other in a diametric direction of the rotor body, with the peripheral face of the rotor body further including a second slot, with the second float including a housing slideably received in the second slot, with the housing of the second float having an opening facing the interior of the rotor body, with the second float further including an isolating member connecting the housing of the second float to the rotor body, with the isolating member of the second float sealing the second slot, with the telescopic movement control module surrounding a portion of the outer surface of the rotor body, with the telescopic movement control module controlling telescopic movement of at least one of the first and second floats and synchronously moving the first and second floats relative to the rotor body.

15. The buoyancy-driven kinetic energy generating apparatus as claimed in claim 14, with the telescopic movement control module further including a connecting module connected between the first and second floats, with the connecting module including two fixing members respectively fixed to inner walls of the housings of the first and second floats, and with the connecting module further including a connecting rod having two ends respectively fixed to the two fixing members.

16. The buoyancy-driven kinetic energy generating apparatus as claimed in claim 14, with the telescopic movement control module including a pressing board, with the pressing board including a movement control section and a maintaining section following the movement control section in a rotating direction of the rotor body, with a spacing between the movement control section and the rotating center of the rotor in the movement plane decreasing from a point of the movement control section toward the maintaining section, and with an inner surface of the maintaining section concentric to the peripheral face of the rotor body.

17. The buoyancy-driven kinetic energy generating apparatus as claimed in claim 14, with the telescopic movement control module including two rails, with each of the two rails being arcuate and parallel to and spaced from each other, forming a passage between the two rails, with each of the two rails including a movement control section and a maintaining section following the movement control section in a rotating direction of the rotor body, with a spacing between an outer surface of the movement control section of each of the two rails to the rotating center of the rotor body in the movement plane increasing from a point of the movement control section toward a connection between the movement control section and the maintaining section, and with an outer surface of the maintaining section of each of the two rails being concentric to the peripheral face of the rotor body.

18. The buoyancy-driven kinetic energy generating apparatus as claimed in claim 17, with the housing of each of the first and second floats including a guiding member mounted on the outer surface of the housing, with the guiding member of each of the first and second floats having a roller, with the roller of the first float or the second float moving through the passage and contacting outer surfaces of the maintaining sections and the movement control sections of the two rails when the first float or the second float moves through the two rails.

19. The buoyancy-driven kinetic energy generating apparatus as claimed in claim 18, with the peripheral face of the rotor body further including a third slot and a fourth slot, with the at least one float further including a third float and a fourth float diametrically opposed to the third float, with each of the third and fourth floats located between the first and second floats, with the third float including a housing slideably received in the third slot, with the housing of the third float having an opening facing the interior of the rotor body, with the third float further including an isolating member connecting the housing of the third float to the rotor body, with the isolating member of the third float sealing the third slot, with the fourth float including a housing slideably received in the fourth slot, with the housing of the fourth float having an opening facing the interior of the rotor body, with the fourth float further including an isolating member connecting the housing of the fourth float to the rotor body, with the isolating member of the fourth float sealing the fourth slot, with the housing of each of the third and fourth floats including a guiding member mounted on the outer surface of the housing, with the guiding member of each of the third and fourth floats having a roller, and with the roller of the third float or the fourth float moving through the passage and contacting outer surfaces of the maintaining sections and the movement control sections of the two rails while the third float or the fourth float moves through the two rails.

20. The buoyancy-driven kinetic energy generating apparatus as claimed in claim 19, with the rotor further including a plurality of outer tracks and a ring connecting the plurality of outer tracks, with the plurality of outer tracks connected to the rotor body, and with each of the first, second, third and fourth floats including a limiting member slideably mounted in one of the plurality of outer tracks.

21. The buoyancy-driven kinetic energy generating apparatus as claimed in claim 19, with the isolating member of each of the first, second, third and fourth floats being made of an elastic leakproof material and including a first end fixed to the peripheral face of the rotor body and a second end fixed to an outer face of one of the first, second, third and fourth floats.

22. The buoyancy-driven kinetic energy generating apparatus as claimed in claim 19, with the outer surface of the housing of each of the first, second, third and fourth floats being arcuate and having a curvature corresponding to a curvature of the peripheral face of the rotor body.

23. The buoyancy-driven kinetic energy generating apparatus as claimed in claim 19, with the housing of each of the first, second, third and fourth floats further including a liquid breaking portion in a front end of the housing in the rotating direction, with the liquid breaking portion being V-shaped in cross section and including two sides meeting at an edge and respectively connected to two lateral sides of the housing, and with the outer surface of the housing extending between the two lateral sides of the housing.

24. The buoyancy-driven kinetic energy generating apparatus as claimed in claim 7, with the isolating member of the first float being made of an elastic leakproof material and including a first end fixed to the peripheral face of the rotor body and a second end fixed to an outer face of the first float.

25. The buoyancy-driven kinetic energy generating apparatus as claimed in claim 7, with the outer surface of the housing of the first float being arcuate and having a curvature corresponding to a curvature of the peripheral face of the rotor body.

26. The buoyancy-driven kinetic energy generating apparatus as claimed in claim 7, with the housing of the first float further including a liquid breaking portion in a front end of the housing in the rotating direction, with the liquid breaking portion being V-shaped in cross section and including two sides meeting at an edge and respectively connected to two lateral sides of the housing, and with the outer surface of the housing extending between the two lateral sides of the housing.

27. A method for generating kinetic energy using the buoyancy-driven kinetic energy generating apparatus as claimed in claim 1, with the method comprising:
filling a liquid into the tank to provide the rotor body with a pre-buoyancy; and
controlling the float to telescope relative to the rotor body, causing a change in local buoyancy of the rotor body to imbalance the rotor body and to cause rotation of the rotor body about the rotating axis,
with the float completing a telescopic cycle while the float rotates a turn together with the rotor body about the rotating axis, with the telescopic cycle including a float hidden stroke, a float gradual extending stroke, a float completely exposed stroke and a float gradual retracting stroke in sequence, with the tank including a float hidden section, a float gradual extending section, a float completely exposed section and a float gradual retracting section in sequence in a rotating direction of the rotor, with the float hidden section, the float gradual extending section, the float completely exposed section and the float gradual retracting section corresponding to the float hidden stroke, the float gradual extending stroke, the float completely exposed stroke and the float gradual retracting stroke, respectively,
wherein the float maintains in a maximal retraction state having a maximal retraction magnitude when located in the float hidden section,
wherein when the float is driven by the rotating rotor body to move from the float hidden section into the float gradual extending section, the float undergoes the float gradual extending stroke, and the extension magnitude of the float increases gradually until the float enters the float completely exposed section where the extension magnitude of the float is maximal,
wherein the float undergoes the float completely exposed stroke in the float completely exposed section and maintains a maximal extension magnitude to drive the rotor body to rotate,
wherein the float is driven by the rotating rotor body to move from the float completely exposed section into the float gradual retracting section,
wherein the float undergoes the float gradual retracting stroke, the extension magnitude of the float decreases gradually in the float gradual retracting section until the float enters the float hidden section and then undergoes the float hidden stroke in the maximal retraction state.

28. The method as claimed in claim 27, wherein the float gradual extending section is located below a level of the liquid, and the float gradual retracting section is located above the level of the liquid.

29. The method as claimed in claim 27, wherein the float hidden section is opposite to the float completely exposed section in a diametric direction of the rotor body, the float gradual extending section is opposite to the float gradual retracting section in a diametric direction of the rotor body, and the float hidden section, the float gradual extending section, the float completely exposed section and the float gradual retracting section extending through a same angle.

30. The method as claimed in claim 27, with the at least one float includes a first float and a second float opposed to the first float in a diametric direction of the rotor body, with one of the first and second floats undergoing the float hidden stroke while another of the first and second floats undergoes the float completely exposed stroke, with one of the first and second floats undergoing the float gradual extending stroke while the other of the first and second floats undergoes the float gradual retracting stroke.

31. The method as claimed in claim 27, wherein the extension magnitude of the at least one float forms an arcuate path during the float gradual extending stroke, the float completely exposed stroke and the float gradual retracting stroke.

32. The method as claimed in claim 31, wherein the extension magnitude of the at least one float forms an arcuate path having increasing radiuses of curvature along with rotational movement of the rotor body about the rotating axis during the float gradual extending stroke, the extension magnitude of the at least one float forms an arcuate path having a uniform radius of curvature along with the rotational movement of the rotor body during the float completely exposed stroke, and the extension magnitude of the at least one float forms an arcuate path having decreasing radiuses of curvature along with the rotational movement of the rotor body during the float gradual retracting stroke.
